(19) United States
(12) Patent Application Publication
(10) Pub. No.: US 2020/0285446 A1
(43) Pub. Date: Sep. 10, 2020

(54) ARITHMETIC DEVICE FOR NEURAL NETWORK, CHIP, EQUIPMENT AND RELATED METHOD

(71) Applicant: SZ DJI TECHNOLOGY CO., LTD., Shenzhen (CN)

(72) Inventors: Feng HAN, Shenzhen (CN); Peng LI, Shenzhen (CN); Qian GU, Shenzhen (CN)

(21) Appl. No.: 16/884,609

(22) Filed: May 27, 2020

Related U.S. Application Data
(63) Continuation of application No. PCT/CN2017/114079, filed on Nov. 30, 2017.

(51) Int. Cl. G06F 7/544; G06N 3/04

(52) U.S. Cl. CPC G06F 7/5443; G06N 3/04

(57) ABSTRACT

An arithmetic device for a neural network includes a controller and multiply-accumulate unit groups. A multiply-accumulate unit group includes a filter register and a plurality of computing units, and the filter register is connected to the plurality of computing units. The controller is configured to generate control information and transmit the control information to the plurality of computing units. The filter register is configured to cache filter weighted values of multiply-accumulate operations to be performed. The plurality of computing units is configured to cache input feature values of the multiply-accumulate operations to be performed and perform the multiply-accumulate operations on the filter weighted values and the input feature values according to received control information.

### CROSS-REFERENCE TO RELATED APPLICATION

This application is a continuation of International Application No. PCT/CN2017/114079, filed Nov. 30, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a neural network and, more particularly, to an arithmetic device for a neural network, a chip, an equipment and a related method.

### BACKGROUND

A deep neural network is a machine learning algorithm widely used in computer vision tasks such as target recognition, target detection, image semantic segmentation, and the like. The deep neural network includes an input layer, a plurality of hidden layers, and an output layer. The output of each layer in the deep neural network is the sum of products of a set of weighted values and corresponding input feature values (i.e., multiply-accumulate). The output of each hidden layer may be also referred to as an output feature value, which may be used as an input feature value for a next hidden layer or output layer.

A deep convolutional neural network is a deep neural network that the arithmetic operation of at least one hidden layer is a convolution arithmetic operation. In the existing technology, the arithmetic device used to implement the arithmetic process of the deep convolutional neural network is a graphic processing unit (GPU) or a neural network dedicated processor. The arithmetic process based on the GPU may require more data move operations in the entire arithmetic process, resulting in lower efficiency of data processing. In addition, in the arithmetic process based on the neural network dedicated process, an instruction set architecture of the neural network dedicated processor may require complicated control logic to complete tasks such as fetching instruction, decoding, and the like, resulting in a relatively large chip area required by the control logic. Furthermore, the neural network dedicated processor may require toolchain support such as a compiler, and the like, which may have high development difficulty.

### SUMMARY

In accordance with the disclosure, an arithmetic device for a neural network is provided in the present disclosure. The arithmetic device includes a controller and multiply-accumulate unit groups. A multiply-accumulate unit group includes a filter register and a plurality of computing units, and the filter register is connected to the plurality of computing units. The controller is configured to generate control information and transmit the control information to the plurality of computing units. The filter register is configured to cache filter weighted values of multiply-accumulate operations to be performed. The plurality of computing units is configured to cache input feature values of the multiply-accumulate operations to be performed and perform the multiply-accumulate operations on the filter weighted values and the input feature values according to received control information.

Also in accordance with the disclosure, an arithmetic device for a neural network is provided in the present disclosure. The arithmetic device includes a controller and a plurality of multiply-accumulate unit groups. Each multiply-accumulate unit group includes computing units and a filter register connected to the computing units. The controller is configured to generate control information and transmit the control information to the computing units. Each filter register is configured to cache filter weighted values of multiply-accumulate operations to be performed. Each computing unit is configured to cache input feature values of the multiply-accumulate operations to be performed and perform the multiply-accumulate operations on the filter weighted values and the input feature values according to control information transmitted by the controller. In the plurality of multiply-accumulate unit groups, computing units of a first multiply-accumulate unit group and computing units of another multiply-accumulate unit group are connected in a preset order; or computing units of a first multiply-accumulate unit group and computing units of two other multiply-accumulate unit groups are connected in a preset order; and the order connection is configured to accumulate multiply-accumulate results of the computing units connected in the preset order.

Also in accordance with the disclosure, a chip for a neural network is provided in the present disclosure. The chip includes an arithmetic device, and a communication interface, configured to obtain data to be processed by the arithmetic device and output arithmetic results of the arithmetic device. The arithmetic device includes a controller and multiply-accumulate unit groups. A multiply-accumulate unit group includes a filter register and a plurality of computing units, and the filter register is connected to the plurality of computing units. The controller is configured to generate control information and transmit the control information to the plurality of computing units. The filter register is configured to cache filter weighted values of multiply-accumulate operations to be performed. The plurality of computing units is configured to cache input feature values of the multiply-accumulate operations to be performed and perform the multiply-accumulate operations on the filter weighted values and the input feature values according to received control information.

### BRIEF DESCRIPTION OF THE DRAWINGS

FIG. 1 illustrates a schematic of a convolutional layer operation;

FIG. 2 illustrates a schematic block diagram of an arithmetic device for a neural network according to various disclosed embodiments of the present disclosure;

FIG. 3 illustrates another schematic block diagram of an arithmetic device for a neural network according to various disclosed embodiments of the present disclosure;

FIG. 4 illustrates another schematic block diagram of an arithmetic device for a neural network according to various disclosed embodiments of the present disclosure;

FIG. 5 illustrates another schematic block diagram of an arithmetic device for a neural network according to various disclosed embodiments of the present disclosure;

FIG. 6 illustrates a schematic block diagram of a computing unit of an arithmetic device for a neutral network according to various disclosed embodiments of the present disclosure;

FIG. 7 illustrates a schematic flow chart of a method for generating an input feature value read address according to various disclosed embodiments of the present disclosure;

FIG. 8 illustrates another schematic flow chart of a method for generating an input feature value read address according to various disclosed embodiments of the present disclosure;

FIG. 9 illustrates another schematic flow chart of a method for generating an input feature value read address according to various disclosed embodiments of the present disclosure;

FIG. 10 illustrates another schematic flow chart of a method for generating an input feature value read address according to various disclosed embodiments of the present disclosure;

FIG. 11 illustrates a schematic flow chart for generating a filter weighted value read address according to various disclosed embodiments of the present disclosure;

FIG. 12 illustrates another schematic flow chart for generating a filter weighted value read address according to various disclosed embodiments of the present disclosure;

FIG. 13 illustrates another schematic flow chart of a method for generating an input feature value read address according to various disclosed embodiments of the present disclosure;

FIG. 14 illustrates another schematic flow chart for generating a filter weighted value read address according to various disclosed embodiments of the present disclosure;

FIG. 15 illustrates another schematic of a convolutional layer operation;

FIG. 16 illustrates a schematic block diagram of a chip configured for a neutral network according to various disclosed embodiments of the present disclosure;

FIG. 17 illustrates a schematic block diagram of an equipment configured for a neutral network processing according to various disclosed embodiments of the present disclosure; and

FIG. 18 illustrates a schematic flow chart of a method for processing a neutral network according to various disclosed embodiments of the present disclosure.

### DETAILED DESCRIPTION OF THE EMBODIMENTS

In a deep convolutional neutral network, a hidden layer may be a convolutional layer. A set of weighted values corresponding to the convolutional layer may be called a filter or a convolutional kernel. Both the filter and input feature values may be expressed as multi-dimensional matrices. Correspondingly, the filter expressed as the multi-dimensional matrix may be called a filter matrix, and the input feature values expressed as the multi-dimensional matrix may be called an input feature value matrix. An operation of the convolutional layer may be called a convolution operation, which may refer to an inner product operation performed on a portion of the input feature values of the input feature value matrix and the weighted values of the filter matrix.

The operation process of each convolutional layer in the deep convolutional neural network may be programmed into software, and then the software may be run in an arithmetic device to obtain an output result of each layer, that is an output feature matrix. For example, taking an upper left corner of the input feature matrix of each layer as a starting point and using a size of the filter as a window, the software may fetch the data of one window from the feature value matrix and perform the inner product operation with the filter each time using a sliding window manner. After the data in a lower right corner window of the input feature matrix and the filter complete the inner product operation, a two-dimensional output feature matrix of each layer may be obtained. The software may repeat the above-mentioned process till generating an entire output feature matrix for all layers.

The process of the convolutional layer operation is the following. A filter-sized window may be slid over an entire input image (i.e., the input feature matrix), the inner product operation may be performed on the input feature values covered in the window and the filter at each time, where a stride of the sliding window may be 1. For example, taking the upper left corner of the input feature matrix as the starting point and using the size of the filter as the window, the stride of the sliding window may be 1, and the inner product operation may be performed on the input feature values of one window fetched from the feature value matrix and the filter each time. After the inner product operation of the data in the lower right corner of the input feature matrix and the filter is completed, a two-dimensional output feature matrix of the input feature matrix may be obtained.

For example, as shown in FIG. 1, it is assumed that an input feature matrix A1 corresponding to an input image is a 3×4 matrix as shown below:

x11 x12 x13 x14

x21 x22 x23 x24

x31 x32 x33 x34;

a filter matrix B1 is a 2×2 matrix as shown below:

w11 w12

w21 w22;

such that a size for defining the sliding window is 2×2, as shown in FIG. 1.

The process of the convolutional layer operation is that the sliding window may be slid at the stride interval of 1 on a 3×4 input image, and the inner product may be performed on 4 input feature values covered by the sliding window and the filter matrix each time to obtain one output result. For example, 4 input feature values covered by the sliding window one time are x22, x23, x32 and x33, so the corresponding convolution operation is x22×w11+x23×w12+x32×w21+x33×w22, thereby obtaining an output result y22. The sliding window sequentially slides from the upper left corner to the lower right corner of the input image according to the stride. That is, after all convolution operations are completed, all output results may constitute an output image. As shown in FIG. 1, an output feature matrix C1 corresponding to the output image may be a 2×3 matrix as shown below:

y11y12y13

y21y22y23; where,

y11=x11×w11+x12×w12+x21×w21+x22×w22,

y21=x21×w11+x22×w12+x31×w21+x32×w22,

y12=x12×w11+x13×w12+x22×w21+x23×w22,

y22=x22×w11+x23×w12+x32×w21+x33×w22,

y13=x13×w11+x14×w12+x23×w21+x24×w22,

y23=x23×w11+x24×w12+x33×w21+x34×w22.

It can be seen from the above-mentioned description that the convolution operation shown in FIG. 1 includes 6 inner product operations, where the input feature values corresponding to each inner product operation may be different, but the filter may be same.

In order to better understand the technical solutions provided by the present disclosure, the terms involved in the embodiments of the present disclosure may be first introduced.

The input image represents an image to be processed.

The input feature matrix represents an image matrix corresponding to the input image. The input feature matrix may be a two-dimensional matrix. For example, the input feature matrix may be an H×W matrix. The input feature matrix may also be a multi-dimensional matrix. For example, the input feature matrix may be an H×W×R matrix, which may be understood as R channels of the two-dimensional H×W matrices. For example, a feature matrix corresponding to a color image is H×W×3, that is, 3 channels of the two-dimensional H×W matrices, and the 3 matrices respectively correspond to three primary colors RGB of the image. H is called a height of the input feature matrix, W is called a width of the input feature matrix, and R is called a depth of the input feature matrix.

The input feature values represent all values in the input feature matrix.

The filter matrix represents a matrix of weighted values used by the convolutional layer. The filter matrix may be a two-dimensional matrix. For example, the filter matrix may be an H×W matrix. The filter matrix may also be a multi-dimensional matrix. For example, the filter matrix may be an H×W×R matrix, which may be understood as R two-dimensional H×W matrices. For example, a filter matrix corresponding to a color image is a three-dimensional H×W×3 matrix, that is, 3 two-dimensional H×W matrices, and the 3 matrices respectively correspond to three primary colors RGB of the image. H is called a height of the filter matrix, W is called a width of the filter matrix, and R is called a depth of the filter matrix.

The filter weighted values represent all values in the filter matrix, that is, the weighted values used by the convolutional layer. In the example with reference to FIG. 1, the filter weighted values include w11, w12, w21, and w22.

The output feature matrix represents a matrix obtained by performing the convolution operation on the input feature matrix and the filter matrix. Similarly, the output feature matrix may be a two-dimensional matrix. For example, the output feature matrix may be an H×W matrix. The output feature matrix may also be a multi-dimensional matrix. For example, the filter matrix may be an H×W×R matrix, where H is called a height of the output feature matrix, W is called a width of the output feature matrix, and R is called a depth of the output feature matrix. It should be understood that the depth of the output feature matrix may be consistent with the depth of the filter matrix.

As described above, the existing technology may have more data move operations in processing the neural network, resulting in lower efficiency of the data processing, or may have higher design complexity of the control logic, resulting in an excessively large chip occupied by the control logic.

To solve the above-mentioned problems, the present provides an arithmetic device for the neural network, a chip and an equipment, which may not only enable a plurality of computing units (CUs) to share a same filter register, and also reduce the design complexity of the control logic.

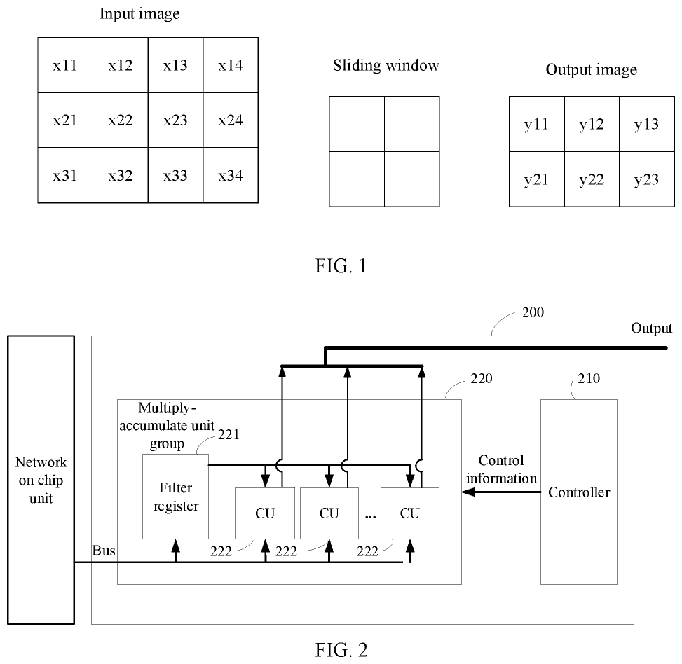

FIG. 2 illustrates a schematic block diagram of an arithmetic device 200 configured for a neural network according to various disclosed embodiments of the present disclosure. The arithmetic device 200 may include a controller 210 and a multiply-accumulate unit group 220. The multiply-accumulate unit group 220 may include a filter register 221 and a plurality of computing units 222. The filter register 221 may be connected to the plurality of computing units 222.

The controller 210 may be configured to generate control information and transmit the control information to the computing units 222.

For example, the controller 210 may be configured to generate required control information for performing the multiply-accumulate operations, by the computing units 222, in the multiply-accumulate unit group 220.

It should be noted that, in the arithmetic device 200 provided by the present disclosure, all multiply-accumulate unit groups 220, that is, all computing units 222 may share a set of control information generated by the controller 210. In other words, the controller may be configured to transmit the control information to all computing units 222 in the arithmetic device 200.

It should be understood that, in order to facilitate the drawing, a connection between the controller 210 and the multiply-accumulate unit group 220 in FIG. 2 may be configured to indicate that the controller 210 may be connected to each computing unit 222 in the multiply-accumulate unit group 220.

Optionally, the control information may include a multiply-accumulate enable signal.

For example, only when the multiply-accumulate enable signal is valid, the computing units 222 may be instructed to perform the multiply-accumulate operations on the filter weighted values and the input feature values.

Optionally, the control information may further include a filter weighted value read address and/or an input feature value read address.

For example, the filter weighted value read address may be configured to instruct the computing units 222 to read certain filter weighted values in the filter register 221. The input feature value read address may be configured to instruct the computing units 222 to read certain input feature values in a local cache space.

Optionally, the control information may further include at least one of the following: addresses of the filter weighted values in the filter register 221 and cache addresses of the input feature values in the computing units 222.

Optionally, the computing units 222 may be configured to read the corresponding filter weighted values from the filter register and read the corresponding input feature values from the local cache space according to preset information. In such scenario, the control information may not be required to carry related read address information.

The filter register 221 may be configured to cache the filter weighted values of the multiply-accumulate operations to be performed.

The computing units 222 may be configured to cache the input feature values of the multiply-accumulate operations to be performed and perform the multiply-accumulate operations on the filter weighted values and the input feature values according to received control information.

It should be understood that the filter register 221 may pre-cache the filter weighted values of the multiply-accumulate operations to be performed and the computing units 222 may pre-cache the input feature values of the multiply-accumulate operation to be performed. The filter weighted values may be 1*1, 2*2, 3*3, . . . , n*n, or may be 1*n, 2*3, 3*5, . . . , n*m.

For example, as shown in FIG. 2, the filter register 221 and the computing units 222 may receive and cache corresponding cached data from a bus.

Optionally, the bus may be a row bus (XBUS).

For example, a network on chip unit may transmit the input feature values and the filter weighted values to the computing units 200 through the XBUS. For example, the input feature values may be transmitted to the computing units 222 in the arithmetic device 200 and the filter weighted values may be transmitted to the filter register 221 in the arithmetic device 200.

In some embodiments, the bus may be referred to XBUS as example hereinafter. In actual applications, the bus may be one of other buses, which may not be limited in the embodiments of the present disclosure.

For example, an interface between each computing unit 222 and XBUS may have a number, called a feature value number. Different computing units 222 in a same multiply-accumulate unit 220 may have different interface addresses. Each computing unit 222 may be configured to receive and cache the input feature value from the bus where a destination interface address matches the interface address of the computing unit 222, and the above-mentioned matching may be referred to a same address.

Similar to the computing units 222, an interface between each filter register 221 and XBUS may have a number, called a weighted value interface number. The filter register 221 may be configured to receive and cache the filter weighted value from the bus where a destination interface address matches the interface address of the filter register.

The convolution operation shown in FIG. 1 is taken as an example. It is assumed that the multiply-accumulate unit group 220 has six computing units 222, a first computing unit 222 may cache the input feature values x11, x12, x21, and x22, a second computing unit 222 may cache the input feature values x21, x22, x31, and x32, a third computing unit 222 may cache the input feature values x12, x13, x22, and x23, a fourth computing unit 222 may cache the input feature values x22, x23, x32, and x33, a fifth computing unit 222 may cache the input feature values x13, x14, x23, and x24, and a sixth computing unit 222 may cache the input feature values x23, x24, x33, and x34. The filter register 221 in the multiply-accumulate unit group 220 may cache the filter weighted values w11, w12, w21, and w22. When the multiply-accumulate enable signal in the control information is detected to be valid, each computing unit 222 may read the filter weighted values w11, w12, w21, and w22 from the filter register, and perform the multiply-accumulate operation (i.e., the inner product operation) on the filter weighted values and locally cached input feature values, thereby obtaining the operation result. It should be understood that the operation results y11, y21, y12, y22, y13, and y23 may be respectively obtained by the computations of six computing units 222. An output feature matrix C1 may be obtained by the arithmetic device 200 according to the operation results of the six computing units.

It should be understood that, in the above-mentioned embodiments, the entire output feature matrix C1 may be obtained by the arithmetic device at one time, which may not be limited in the embodiments of the present disclosure. In actual applications, when the output feature matrix is extremely large and the computing units included in the arithmetic device may not output all values of the entire output feature matrix, multiple operations may be used to obtain the entire output feature matrix. For example, it is assumed that the multiple-accumulate unit group only includes two computing units, three operations may be required to be performed to obtain the entire output feature matrix.

It should be understood that, in the above-mentioned embodiments, suitable input feature values may be selected and cached to the computing units for the computations according to a magnitude relationship between the computing units and the input image. For example, the multiple-accumulate unit group may only include three computing units, the input feature values x11, x12, x21, and x22 may be cached in the first computing unit, the input feature values x12, x13, x22, and x23 may be cached in the second computing unit, the input feature values x13, x14, x23, and x24 may be cached in the third computing unit, and the filter weighted values w11, w12, w21, and w22 may be cached in the filter register 221. Currently, three operations may be performed first, and then the input feature values x21, x22, x31, and x32 may be cached in the first computing unit, the input feature values x22, x23, x32, and x33 may be cached in the second computing unit, the input feature values x23, x24, x33, and x34 may be cached in the third computing unit.

It should be understood that, in the above-mentioned embodiments, each computing unit 222 may perform one convolution operation. However, in actual applications, the computing unit may first compute one input feature value or perform the convolution operation on one row of feature values, and then output the result to an external device or accumulate the result with a next result in the computing unit, thereby obtaining a final convolution operation result. The next computation result may be a next computed input feature value or a next row of the convolution operation. For example, the input feature values x11 and x12 may be cached in the first computing unit, the input feature values x12 and x13 may be cached in the second computing unit, the input feature values x13 and x14 may be cached in the third computing unit, and the filter weighted values w11, w12, w21, and w22 may be cached in the filter register 221. Currently, three operations may be performed first, and then the input feature values x21 and x22 may be cached in the first computing unit, the input feature values x22 and x23 may be cached in the second computing unit, the input feature values x23 and x24 may be cached in the third computing unit. Then, three operations may be performed, and two obtained results may be accumulated to obtain final three convolution results.

In the arithmetic device provided by the present disclosure, one multiply-accumulate unit group may include one filter register and the plurality of multiply-accumulate units, and the plurality of multiply-accumulate units may acquire the filter weighted values from the filter register. In other words, the filter register may be equivalent to a shared filter register of the plurality of computing units, and each computing unit may not be required to allocate a storage space to store the filter weighted values. Therefore, the arithmetic device provided by the present disclosure may make the plurality of computing units to share a same filter register, thereby reducing storage requirement to a certain extent. Furthermore, the filter weighted values may be pre-cached in the filter register, and the input feature values may be pre-cached in the computing units. It should be understood that, by pre-caching the filter weighted values and the input feature values, data reuse may be improved, and data move operations may be reduced.

Furthermore, in the arithmetic device provided by the present disclosure, one controller may transmit signal information to all computing units. In other words, the arithmetic device provided by the present disclosure may only need one controller to control all modules, and compared with the exiting technology, the design complexity of the control logic may be effectively reduced.

It can be seen from the above-mentioned embodiments, the arithmetic device provided by the present disclosure may use one controller to control all modules, and compared with the exiting technology, the design complexity of the control logic may be effectively reduced, thereby reducing the chip area required by the controller and further reducing the volume of the arithmetic device. At the same time, the arithmetic device provided by the present disclosure may make the plurality of computing units to share one filter register, thereby reducing the required cache size and further reducing the energy efficiency ratio of the arithmetic device. Furthermore, for the arithmetic device provided by the present disclosure, the filter weighted values and the input feature values may be pre-cached, so the data reuse may be improved, and the data move operations may be reduced.

Optionally, the arithmetic device 200 provided by the present disclosure may include the plurality of multiply-accumulate unit groups 220 as shown in FIG. 2.

It should be noted that, in conjunction with FIG. 2, the above-mentioned connection relationship between the multiply-accumulate unit group 220 and the controller 210 and the connection relationship between the filter register 221 and the computing units 222 in the multiply-accumulate unit group 220 may be applied to one embodiment, and also be applied to various embodiments described hereinafter.

In the arithmetic device provided by the present disclosure, one controller may be configured to transmit control information to each computing unit of the plurality of multiply-accumulate unit groups, and compared with the exiting technology, the design complexity of the control logic of the neural networks may be effectively reduced.

Optionally, as an implementation manner, the arithmetic device 200 may include N multiply-accumulate unit groups 220 connected to a same bus, and the controller 210 may be configured to transmit control information to each computing unit in the N multiply-accumulate unit groups 220, where N is a positive integer.

For example, the filter registers 221 and the computing units 222 in the N multiply-accumulate unit groups 220 may all be connected to a same bus. The computing units 220 in the N multiply-accumulate unit groups 220 may all be configured to receive control information transmitted by the controller 210.

It is assumed that one multiply-accumulate unit group 220 includes S computing units, so the arithmetic device provided by the embodiments may output S×N operation results at one time, which may improve processing parallelism.

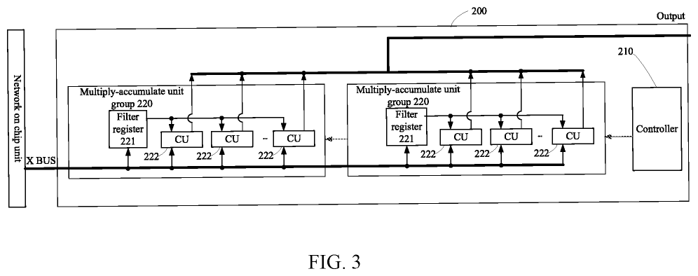

For example, it is assumed that N is equal to 2, the arithmetic device 200 provided in the embodiments may be shown in FIG. 3.

It should be understood that FIG. 3 may merely be exemplary and may not be limiting in various embodiments of the present disclosure. In actual applications, a value of N or S may be adaptively configured according to actual requirements.

Optionally, in the above-mentioned embodiments in conjunction with FIG. 3, interface addresses of the computing units between different multiply-accumulate unit groups in the plurality of multiply-accumulate unit groups may be same; or interface addresses of the computing units between different multiply-accumulate unit groups in the plurality of multiply-accumulate unit groups may be different.

Taking FIG. 3 as an example, it is assumed that the cached filter weighted values in the filter register in a left multiply-accumulate unit group are different from the cached filter weighted values in the filter register in a right multiply-accumulate unit group in FIG. 3. In such situation, the interface addresses of the computing units in the left multiply-accumulate unit group may be same as the interface addresses of the computing units in the right multiply-accumulate unit group.

The arithmetic device provided by the embodiments may implement and execute the convolution operations of a same input feature map based on two different filters in parallel.

Optionally, in the above-mentioned embodiments in conjunction with FIG. 3, interface addresses of the filter registers between different multiply-accumulate unit groups in the plurality of multiply-accumulate unit groups may be same; or interface addresses of the filter registers between different multiply-accumulate unit groups in the plurality of multiply-accumulate unit groups may be different.

Still taking FIG. 3 as an example, it is assumed that the interface addresses of the computing units in the left multiply-accumulate unit group are same as the interface addresses of the computing units in the right multiply-accumulate unit group in FIG. 3. In such situation, the interface address of the filter register in the left multiply-accumulate unit group may be different from the interface address of the filter register in the right multiply-accumulate unit group.

The arithmetic device provided by the embodiments may implement and execute the convolution operations of a same input feature map based on two different filters in parallel.

Still taking FIG. 3 as an example, it is assumed that the interface addresses of the computing units in the left multiply-accumulate unit group are different from the interface addresses of the computing units in the right multiply-accumulate unit group in FIG. 3. In such situation, the interface address of the filter register in the left multiply-accumulate unit group may be same as the interface address of the filter register in the right multiply-accumulate unit group.

The arithmetic device provided by the embodiments may implement and execute the convolution operations of a same input feature map based on a same filter in parallel.

For example, when the depth of the filter matrix is greater than 1, that is, when the depth of the output feature matrix is greater than 1, for the arithmetic device 200 shown in FIG. 2 provided by one embodiment, the interface addresses of the filter registers between different multiply-accumulate unit groups may be different, and the interface addresses of the computing units between different multiply-accumulate unit groups may be same.

For example, one column (partial or total) of each of two two-dimensional output feature matrices may be obtained simultaneously by using the arithmetic device provided by one embodiment.

For example, when the depth of the filter matrix is equal to 1, that is, when the depth of the output feature matrix is equal to 1, for the arithmetic device 200 shown in FIG. 2 provided by one embodiment, the interface addresses of the filter registers between different multiply-accumulate unit groups may be same, and the interface addresses of the computing units between different multiply-accumulate unit groups may be different.

Optionally, as another implementation manner, the arithmetic device 200 may include M multiply-accumulate unit groups 220 which may be connected to M different buses one to one. The computing units of the first multiply-accumulate unit group and the computing units of another multiply-accumulate unit group of the plurality of multiply-accumulate unit group may be connected in a preset order. Or, the computing units of the first multiply-accumulate unit group and the computing units of another two multiply-accumulate unit groups may be connected in a preset order. The order connection may be configured to accumulate the results of the multiply-accumulate operations of the computing units connected in the preset order. The first multiply-accumulate unit group may refer to as any one of the plurality of multiply-accumulate unit groups herein.

For example, the computing units 222 in different multiply-accumulate unit groups of M multiply-accumulate unit groups may be connected in series. For example, an i-th computing unit 222 in the first multiply-accumulate unit group 220 may be connected to an i-th computing unit 222 in the second multiply-accumulate unit group 220, the i-th computing unit 222 in the second multiply-accumulate unit group 220 may also be connected to an i-th computing unit 222 in the third multiply-accumulate unit group 220, the i-th computing unit 222 in the third multiply-accumulate unit group 220 may also be connected to an i-th computing unit 222 in the fourth multiply-accumulate unit group 220, and so on. An i-th computing unit 222 in the M−1-th multiply-accumulate unit group 220 may be connected to an i-th computing unit 222 in the M-th multiply-accumulate unit group 220, where i is 1, . . . , S; and S is a number of computing units 222 included in the multiply-accumulate unit groups 220.

Correspondingly, the accumulation of the results of the multiply-accumulate operations of the computing units connected in the preset order may refer to that the first computing unit in the M multiply-accumulate unit groups may be configured to transmit the multiply-accumulate operation result of the first computing unit to one computing unit connected to the first computing unit; and the second computing unit in the M multiply-accumulate unit groups may be configured to receive the multiply-accumulate operation result of one computing unit connected to the second computing unit and also accumulate an initial multiply-accumulate operation result of the second computing unit and the received multiply-accumulate operation result, thereby obtaining a final multiply-accumulate operation result of the second computing unit.

For example, the connection relationship is assumed as the following: the i-th computing unit 222 in the first multiply-accumulate unit group 220 may be connected to the i-th computing unit 222 in the second multiply-accumulate unit group 220, the i-th computing unit 222 in the second multiply-accumulate unit group 220 may also be connected to the i-th computing unit 222 in the third multiply-accumulate unit group 220, the i-th computing unit 222 in the third multiply-accumulate unit group 220 may also be connected to the i-th computing unit 222 in the fourth multiply-accumulate unit group 220, . . . , the i-th computing unit 222 in the M−1-th multiply-accumulate unit group 220 may also be connected to the i-th computing unit 222 in the M-th multiply-accumulate unit group 220. Therefore, the accumulation of the results of the multiply-accumulate operations of the computing units connected in the preset order may refer to that the multiply-accumulate operation result of the i-th computing unit 222 in the first multiply-accumulate unit group 220 may be transmitted to the i-th computing unit 222 in the second multiply-accumulate unit group 220, and the i-th computing unit 222 in the second multiply-accumulate unit group 220 may accumulate a received operation result and a self-obtained multiply-accumulate operation result to obtain a corresponding result and also transmit a final operation result to the i-th computing unit 222 in the third multiply-accumulate unit group 220, and so on. The i-th computing unit 222 in the M-th multiply-accumulate unit group 220 may accumulate the self-obtained multiple-accumulate operation result and the received operation result of the i-th computing unit 222 in the M−1-th multiply-accumulate unit group 220 to obtain a corresponding operation result. Currently, the obtained operation result may be the accumulation sum of the multiply-accumulate results of the M computing units. It should be understood that the output result of the multiply-accumulate unit group 220 (M) may be the output result of the arithmetic device 200.

It should be understood that the arithmetic device provided by one embodiment may be suitable for the following computation scenario: each computing unit may be configured to merely perform partial convolution operations. For example, each computing unit may be configured to merely perform the multiply-accumulate operations corresponding to one row of weighted values in one entire two-dimensional filter matrix. Then, the accumulation sum of operation results of the plurality of computing units may be used as the inner product corresponding to one entire filter matrix.

Optionally, in one embodiment, when M is greater than the height of the two-dimensional filter matrix, the arithmetic device provided in one embodiment may simultaneously perform convolution operations on the plurality of input feature matrices.

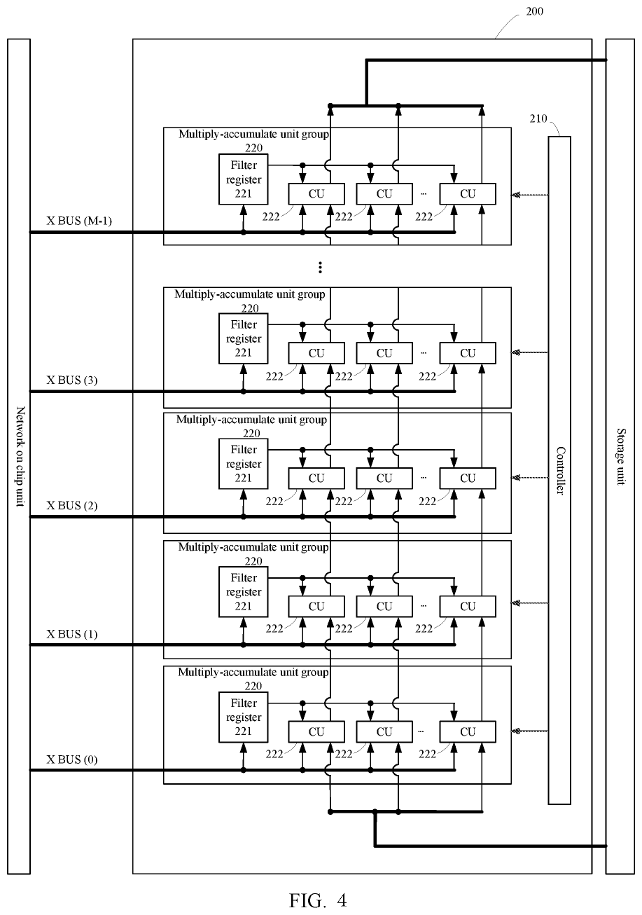

As one example, it is assumed that M is equal to 12, the height of the filter matrix is 3, and the depth of the input feature matrix is 4. Then, the convolution operations may be performed on the first layer input feature values of the input feature matrix and the filter matrix for the first row to the third row of the computing unit array shown in FIG. 4; the convolution operations may be performed on the second layer input feature values of the input feature matrix and the filter matrix for the fourth row to the sixth row of the computing unit array shown in FIG. 4; the convolution operations may be performed on the third layer input feature values of the input feature matrix and the filter matrix for the seventh row to the ninth row of the computing unit array shown in FIG. 4; and the convolution operations may be performed on the fourth layer input feature values of the input feature matrix and the filter matrix for the tenth row to the twelfth row of the computing unit array shown in FIG. 4.

The arithmetic device provided in one embodiment may perform convolution operations of multiple layers of the multiple layer input feature matrix in parallel. It should be understood that the multiple layer input feature matrix mentioned herein may refer to the input feature matrix having a depth greater than 1.

As another example, it is assumed that M is equal to 12, the height of the filter matrix is 3, the depth of the filter matrix is 4, and the depth of the input feature matrix is 1. Then, the convolution operations may be performed on the input feature values and the first layer filter weighted values of the filter matrix for the first row to the third row of the computing unit array shown in FIG. 4; the convolution operations may be performed on the input feature values and the second layer filter weighted values of the filter matrix for the fourth row to the sixth row of the computing unit array shown in FIG. 4; the convolution operations may be performed on the input feature values and the third layer filter weighted values of the filter matrix for the seventh row to the ninth row of the computing unit array shown in FIG. 4; and the convolution operations may be performed on the input feature values and the fourth layer filter weighted values of the filter matrix for the tenth row to the twelfth row of the computing unit array shown in FIG. 4.

The arithmetic device provided in one embodiment may perform convolution operations of a same input feature map based on the multiple layer filter matrix in parallel. It should be understood that the multiple layer filter matrix herein may refer to the filter matrix having a depth greater than 1.

For example, for the convolutional layer operation shown in FIG. 1, the output feature value y11 in the output feature matrix C1 may be obtained below. The computing unit 222(1) may perform the following operation: P1=x11×w11+x12×w12, the computing unit 222(2) may perform the following operation: P2=x21×w21+x22×w22; then, the computing unit 222(1) may transmit the operation result P1 to the computing unit 222(2), and finally the computing unit 222(2) may accumulate the operation results P1 and P2 to obtain the output feature value y11.

The arithmetic device 200 provided in one embodiment may simplify the computation load of a single computing unit 222, thereby improving the design flexibility of the arithmetic device 200.

Optionally, as shown in FIG. 4, M multiply-accumulate unit groups 220 in the arithmetic device 200 provided in one embodiment may form a rectangular array of M rows and 1 column. It is assumed that each multiply-accumulate unit group 220 includes S computing units 222, so M×S computing units 222 may form a rectangular array of M rows and S columns.

The rectangular array formed by the computing units 222 may be called a computing unit array (e.g., MAC cell) hereinafter.

It should be noted that, in the arithmetic device 200 provided in one embodiment, all multiply-accumulate unit groups 200, that is, all computing units 222 may share a set of control information generated by the controller 210, but the control information of two adjacent groups (rows) of multiply-accumulate unit groups 200 may be delayed by one beat.

Optionally, in one embodiment shown in FIG. 4, the interface addresses of partial computing units in different multiply-accumulate unit groups 220 may be same.

For example, if the convolution operations of two adjacent rows of the output feature matrix has partial same input feature values, such partial input feature values may be simultaneously written into two adjacent columns of computing units in two adjacent rows in the computing unit array through XBUS, then the convolution operations of the two computing units may be simultaneously performed to implement the reuse of the input feature values.

It should be understood that FIG. 4 may be merely exemplary and may not be limiting in various embodiments of the present disclosure. In actual applications, the arrangement of the M multiply-accumulate unit groups 220 and the arrangement of all computing units 222 in the M multiply-accumulate unit groups 220 may be adaptively designed according to actual requirements, which may not be limited in the embodiments of the present disclosure.

When the number M of the multiply-accumulate unit groups 220 is less than the height of the filter matrix, the arithmetic device 200 may not obtain the multiply-accumulate operation result corresponding to the entire filter matrix at one time, that is, one time output of the arithmetic device 200 may merely output an intermediate result. In such scenario, the intermediate result may need to be cached first and then be accumulated to the next operation till obtaining the multiply-accumulate operation result corresponding to the entire filter matrix by the accumulation operations.

Optionally, in the above-mentioned embodiments, the input feature values processed by the arithmetic device may include partial or all input feature values of each input feature image of multiple input feature images.

Optionally, in some embodiments, the computing units in at least one multiply-accumulate unit group of the plurality of multiply-accumulate unit groups may be connected to a storage unit. The computing units connected to the storage unit may further be configured to transmit the multiply-accumulate operation result to the storage unit.

Optionally, in some embodiments, the computing units in at least one multiply-accumulate unit group of the plurality of multiply-accumulate unit groups may be connected to the storage unit. The computing units connected to the storage unit may further be configured to receive the data transmitted by the storage unit and accumulate an initial local multiply-accumulate operation result and the received data, thereby obtaining a final local multiply-accumulate operation result.

Optionally, the storage module may be configured to receive the data transmitted by the computing units and the accumulation operations may be performed in the storage module to obtain the intermediate or final multiply-accumulate operation result.

For example, as shown in FIG. 4, if an output result of the multiply-accumulate unit group 220 (M) is an intermediate result of the inner product corresponding to an entire two-dimensional filter matrix, the multiply-accumulate unit group 220 (M) may output the intermediate result to the storage unit, and wait for a next operation that the storage unit may output the intermediate result again to the multiply-accumulate unit group 220 (1) to continue the accumulation operation. In the next operation, the multiply-accumulate unit group 220 (1) may receive the intermediate result from the storage unit and accumulate the intermediate result with the multiply-accumulate operation result of the multiply-accumulate unit group 220 (1) itself.

Optionally, in the above-mentioned embodiments in conjunction with FIG. 4, the interface addresses of the computing units between different multiply-accumulate unit groups in the plurality of multiply-accumulate unit groups may be same; or the interface addresses of the computing units between different multiply-accumulate unit groups in the plurality of multiply-accumulate unit groups may be different.

For example, it is assumed that the cached input feature values of the first computing unit in the multiply-accumulate unit group 220(3) connected to XBUS(3) in FIG. 4 is same as the cached input feature values of the second computing unit in the multiply-accumulate unit group 220(2) connected to XBUS(2) in FIG. 4, so the interface addresses of the first computing unit in the multiply-accumulate unit group 220(3) and the second computing unit in the multiply-accumulate unit group 220(2) may be same.

Still taking FIG. 4 as an example, the cached input feature values of the first computing unit in the multiply-accumulate unit group 220(0) connected to XBUS(0) is different from the cached input feature values of the second computing unit in the multiply-accumulate unit group 220(1) connected to XBUS(1), so the interface addresses of the first computing unit in the multiply-accumulate unit group 220(0) and the second computing unit in the multiply-accumulate unit group 220(1) may be different.

In the arithmetic device provided in one embodiment, the computing unit may receive and cache the corresponding feature values by matching a local interface address with a destination interface address of the input feature values transmitted on the XBUS, so if two computing units need to cache same feature values, it may be implemented by configuring two computing units with a same interface address. Through such operation, it may be implemented that the same input feature value may be read into the plurality of different computing units at one time, which may effectively reduce data move operation, and further improve the energy efficiency ratio of data processing.

Optionally, in the above-mentioned embodiments in conjunction with FIG. 4, alternatively the interface addresses of the filter registers between different multiply-accumulate unit groups in the plurality of multiply-accumulate unit groups may be different.

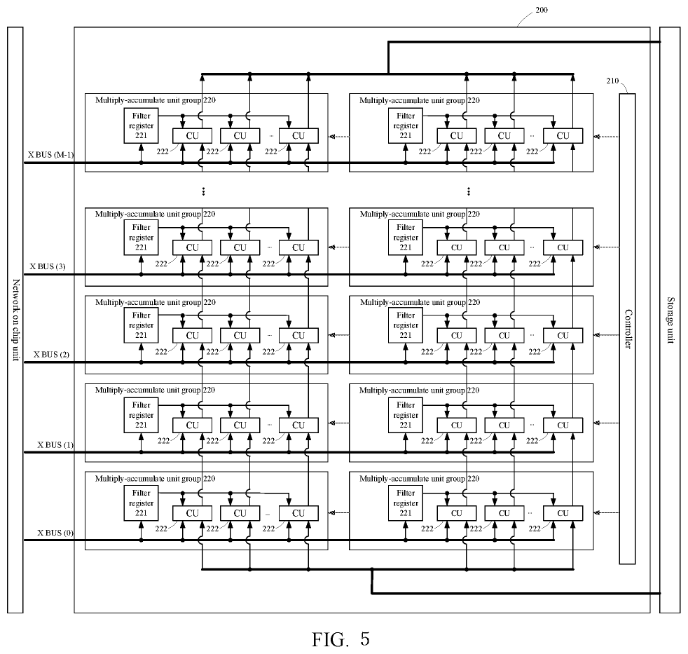

Optionally, as another implementation manner shown in FIG. 5, the arithmetic device 200 may include multiply-accumulate unit groups 220 which are divided into M groups, and each group may include N multiply-accumulate unit groups. Different groups may correspond to different buses, and computing units between different groups may be connected according to a preset order, which may be configured to accumulate the multiply-accumulate results of the computing units connected according to the preset order, where M and N are positive integers. For example, in the plurality of multiply-accumulate unit groups, the computing units of the first multiply-accumulate unit group and the computing units of another multiply-accumulate unit group may be connected according to the preset order. Or the computing units of the first multiply-accumulate unit group and the computing units of another two multiply-accumulate unit groups may be connected according to the preset order, and the order connection may be configured to accumulate the multiply-accumulate results of the computing units connected in the preset order. The first multiply-accumulate unit group may refer to as any one of the plurality of multiply-accumulate unit groups herein.

Optionally, the plurality of multiply-accumulate unit groups 220 may form a rectangular array of M rows and N columns.

For example, all computing units 222 in the plurality of multiply-accumulate unit groups 220 may form a rectangular array. It is assumed that the multiply-accumulate unit group 220 includes S computing units 222, so the computing units 222 in the M×N multiply-accumulate unit groups 220 may form a rectangular array of M×(N×S).

For example, as shown in FIG. 5, N may be equal to 2 as an example.

It should be understood that FIG. 5 may be merely exemplary and may not be limiting in various embodiments of the present disclosure. In the embodiments of the present disclosure, the arrangement manner of each computing unit 222 may not be limited. In actual applications, the arrangement manner of each computing unit 222 may be adaptively designed according to actual requirements.

As an example, the multiply-accumulate unit groups 220 included in the arithmetic device 200 may form a two-dimensional array of 12 rows and 2 columns, where each multiply-accumulate unit group 220 may include 7 computing units 222. In other words, the multiply-accumulate units 222 included in the arithmetic device 200 may form a two-dimensional array of 12 rows and 14 columns of computing units.

For example, the multiply-accumulate results of the input feature values and the filter weighted values calculated by the computing units 222 of a same column may be re-accumulated step by step from bottom to up. In other words, in the same column, the multiply-accumulate operation result generated by the computing units 222 of a lower row may re-accumulated in the computing units 222 of a row higher than such lower row.

Optionally, in the embodiments in conjunction with FIG. 4, a portion of multiply-accumulate unit groups in the plurality of multiply-accumulate unit groups may perform the multiply-accumulate operations, another portion of multiply-accumulate unit groups may not have data to be processed, and multiply-accumulate unit groups connected to an external memory (e.g., the storage unit shown in FIG. 4) may be in such another portion of multiply-accumulate unit groups. In such situation, the computing units in such another portion of multiply-accumulate unit groups may be merely responsible for transferring the multiply-accumulate operation results without accumulating the multiply-accumulate results.

Optionally, in the two-dimensional matrix of the computing units, the computing unit 222 at the lowermost row may accumulate data inputted by the storage unit, and the computing units 222 at the uppermost row may output an output feature value or output an intermediate result of an output feature value.

For example, each interface between a computing unit 222 and XBUS may have a number, called a weighted value interface number, where the computing units 222 in a same row may be configured with different interface numbers, but the computing units 222 in a different row may be configured with a same interface number.

If the interface number of a computing unit 222 is same as the destination interface number of the input feature value on XBUS, the computing unit 222 may receive and cache the input feature values on XBUS.

Similar to the computing unit 222, each interface between a filter register 221 and XBUS may have a number, called a weighted value interface number.

For example, when processing certain layers of the convolutional neural network, the filter registers 221 at a same row may be configured with a same interface number. However, when processing other layers of the convolutional neural network, the filter registers 221 at a same row may be configured with different interface numbers.

For example, if the interface number of a filter register 221 is same as the destination interface number of the filter weighted value on XBUS, the filter register 221 may receive and cache the filter weighted values on XBUS.

Optionally, when the depth of the filter matrix is greater than 1, that is, the depth of the output feature matrix is greater than 1, for the arithmetic device 200 provided in one embodiment and shown in FIG. 5, the interface addresses of the filter registers between different multiply-accumulate unit groups formed in a same group may be different, and the interface addresses of the computing units between different multiply-accumulate unit groups may be same.

For example, by using the arithmetic device provided in one embodiment, each column (partial or all) of two two-dimensional output feature matrices may be obtained simultaneously.

Optionally, when the depth of the filter matrix is equal to 1, that is, the depth of the output feature matrix is equal to 1, for the arithmetic device 200 provided in one embodiment and shown in FIG. 3, the interface addresses of the filter registers between different multiply-accumulate unit groups in a same group may be same, and the interface addresses of the computing units between different multiply-accumulate unit groups may be different.

Optionally, the computing units 222 at a same column may merely generate one output feature value or one intermediate result of an output feature value.

In the above-mentioned embodiments shown in FIG. 4 and FIG. 5, the computation load of each computing unit may be reduced, which may make the arithmetic device design more flexible.

It may be seen from the above-mentioned embodiments that the arithmetic device provided by the present disclosure may make the plurality of computing units to share a same filter register, which may simplify the design complexity of the logic control and have a high degree of parallelism, thereby completing the convolution operations of the deep convolutional neural network in a short duration.

For the embodiments shown in FIG. 4 or FIG. 5, optionally, if the convolution operations of two adjacent rows of the output feature matrix have same partial input feature values, such partial input feature values may be simultaneously written into the input feature registers in two adjacent rows of computing units 222 through XBUS, then the convolution operations of such two rows may be simultaneously computed, thereby implementing the reuse of the input feature values.

For the embodiments shown in FIG. 4 or FIG. 5, optionally, when processing certain layers of the convolutional neural network, N×S column computing units 222 may simultaneously generate output feature values in a same column in adjacent N×S rows in a two-dimensional output feature matrix.

For the embodiments shown in FIG. 4 or FIG. 5, optionally, when processing other layers of the convolutional neural network, N×S column computing units 222 may simultaneously generate output feature values in a same column in adjacent N×S/2 rows in two two-dimensional output feature matrices.

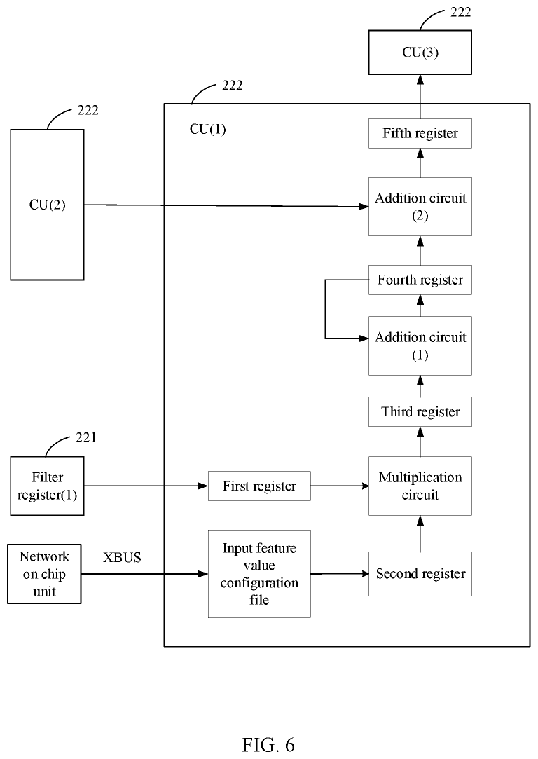

FIG. 6 illustrates a structural schematic of computing units in the arithmetic device provided in the embodiments in FIG. 4 or FIG. 5. For the convenience of distinction and description, the computing unit 222(1) may be taken as an example for description. The computing unit 222(1) may be connected to the computing unit 222(2) and the computing unit 222(3) respectively. The computing unit 222(1) may receive a multiply-accumulate operation result from the computing unit 222(2) and such result may be accumulated with a locally calculated multiply-accumulate operation result to obtain a final operation result, and the final operation result may be transmitted to the computing unit 222(3). As shown in FIG. 6, the computing unit 222(1) may include the following.

An input feature value register may be configured to cache the input feature values on the XBUS and send the input feature values of a specified address into a second register according to the control information transmitted by the controller 210.

For example, the feature values of the address corresponding to the input feature register may be written into a second register according to the control information transmitted by the controller 210.

A first register may be configured to read the filter weighted values of the multiply-accumulate operations to be performed from a filter register (1). The filter register (1) may refer to a filter register which belongs to a same multiply-accumulate unit group 220 as the computing unit 222(1).

The second register may be configured to read the input feature values of the multiply-accumulate operations to be performed from the input feature value register.

A multiplication circuit may be configured to perform the multiplication operation on the filter weighted values in the first register and the input feature values in the second register.

A third register may be configured to store product results of the multiplication circuit.

A first addition circuit may be configured to accumulate the multiplication results stored in the third register to obtain the accumulated results.

A fourth register may be configured to store the accumulated results in the first addition circuit.

A second addition circuit may be configured to receive the operation results from the computing unit (2) and accumulate the operation results of the computing unit (2) with the accumulated results in the fourth register.

A fifth register may be configured to store the accumulated results of the second addition circuit and transmit the accumulated results to the computing unit (3).

Optionally, in some embodiments, the control information may further include the input feature value read address. The computing units 210 may perform the multiply-accumulate operations on the filter weighted values and the input feature values according to received control information, which may include that the computing units 210 may be configured to obtain target feature values from the input feature values and perform the multiply-accumulate operations on the target feature values and the filter weighted values according to the input feature value read address.

For example, for different scenarios, the methods for generating the input feature value read addresses by the controller 210 may be different, which may be described as the following.

Scenario 1: the depth of the input feature matrix may be 1, and a number of digits of the input feature values cached in the computing units may be equal to the width of the filter matrix. The explanation of the depth of the input feature matrix and the width of the filter matrix may refer to the above-mentioned description. The number of digits of the input feature values cached in the computing units may refer to a quantity of the input feature values cached in the computing units. For example, M input feature values are cached in the computing units, so the number of digits of the input feature values cached in the computing unit may be M.

The controller 210 may include a first counter and a first processor. The first counter may be configured to trigger a counting when the multiply-accumulate enable signal is valid and may further be configured to reset a count value when receiving a reset signal transmitted by the first processor. The first processor may be configured to determine whether the count value of the first counter is greater than the width of the filter matrix, and if no, the first processor may increment the input feature read address by 1, and if yes, the first processor may transmit the reset signal to the first counter and reset the input feature value read address. It should be understood that after the input feature value read address is incremented by 1 each time, return to the step of determining whether the multiply-accumulate enable signal is valid.

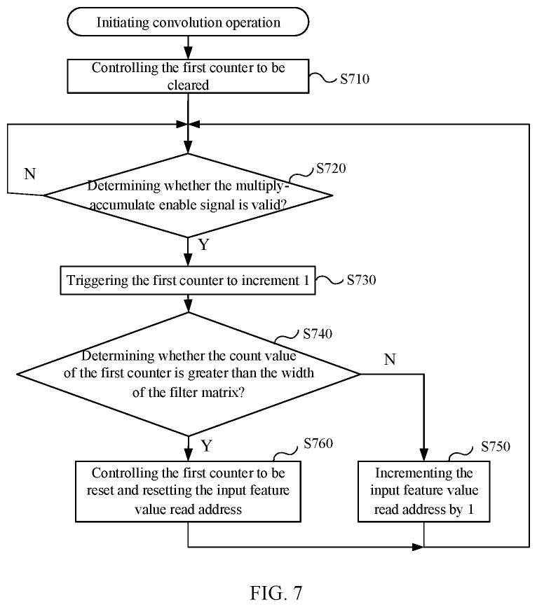

For example, FIG. 7 illustrates a schematic flow chart of a method for generating an input feature value read address according to various disclosed embodiments of the present disclosure. The method may include initiating convolution operations of a hidden layer of the deep convolutional neural network. At S710, the first counter may be controlled to be cleared, and the input feature value read address may be controlled to be cleared. At S720, whether the multiply-accumulate enable signal is valid may be determined; if yes, go to S730, and if no, go back to S720. At S730, the first counter may be triggered to increment 1. At S740, whether the count value of the first counter is greater than the width of the filter matrix may be determined; if no, go to S750, and if yes, go to S760. At S750, the input feature value read address may be incremented by 1; and go back to S720. At S760, the first counter may be controlled to be reset, and the input feature value read address may be reset; and go back to S720.

Scenario 2: the depth of the input feature matrix may be greater than 1, and the number of digits of the input feature values cached in the computing units may be equal to the width of the filter matrix.

The controller 210 may include the first counter, the first processor, the second counter, and the second processor. The first counter may be configured to trigger the counting when the multiply-accumulate enable signal is valid and may further be configured to reset the count value when receiving the reset signal transmitted by the first processor. The first processor may be configured to determine whether the count value of the first counter is greater than the width of the filter matrix; if not, the input feature value read address may be incremented by 1, and if yes, the first processor may transmit the reset signal to the first counter and transmit a triggering count signal to the second counter. The second counter may be configured to trigger the counting when receiving the triggering count signal and further reset the count value when receiving the reset signal transmitted by the second processor. The second processor may be configured to determine whether the count value of the second counter is greater than the depth of the filter matrix; if not, a first read base address may be incremented by 1 stride and the input feature value read address may be assigned to the first read base address, and if yes, the reset signal may be transmitted to the second counter, and the input feature value read address and the first read base address may be reset. A stride direction of the first read base address may be in a depth direction of the input feature matrix. It should be understood that after the input feature value read address is incremented by 1 each time, return to the step of determining whether the multiply-accumulate enable signal is valid.

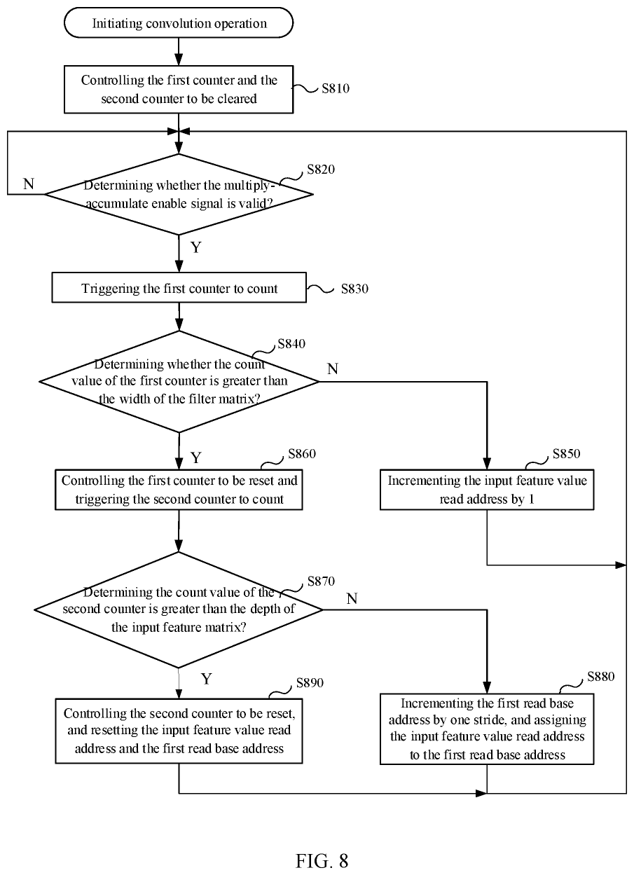

For example, FIG. 8 illustrates another schematic flow chart of a method for generating an input feature value read address according to various disclosed embodiments of the present disclosure. The method may include initiating convolution operations of a hidden layer of the deep convolutional neural network. At S810, the first counter and the second counter may be controlled to be cleared, and the input feature value read address and the first read base address may be reset. At S820, whether the multiply-accumulate enable signal is valid may be determined; if yes, go to S830 and if no, go back to S820. At S830, the first counter may be triggered to incremented 1. At S840, whether the count value of the first counter is greater than the width of the filter matrix may be determined; if no, go to S850, and if yes, go to S860. At S850, the input feature value read address may be incremented by 1; and go back to S820. At S860, the first counter may be controlled to be reset, and the second counter may be triggered to start counting. At S870, whether the count value of the second counter is greater than the depth of the input feature matrix may be determined; if no, go to S880, and if yes, go to S890. At S880, the first read base address may be incremented by one stride, and the input feature value read address may be assigned to the first tread base address; and go back to S820. At S890, the second counter may be controlled to be reset, and the input feature value read address and the first read base address may be reset; and go back to S820.

Scenario 3: the depth of the input feature matrix may be 1, and the number of digits of the input feature values cached in the computing units may be greater than the width of the filter matrix.

The controller 210 may include the first counter and the first processor. The first counter may be configured to trigger the counting when the multiply-accumulate enable signal is valid and may further be configured to reset the count value when receiving the reset signal transmitted by the first processor. The first processor may be configured to determine whether the count value of the first counter is greater than the width of the filter matrix; if no, the input feature value read address may be incremented by 1; if yes, the reset signal may be transmitted to the first counter and the second read base address may be incremented by one stride, and whether the value of the second read base address is greater than a preset value may be determined by the first processor; if no, the input feature value read address may be assigned to the second read base address, and if yes, the input feature value read address and the second read base address may be reset. It should be understood that after the input feature value read address is incremented by 1 each time, return to the step of determining whether the multiply-accumulate enable signal is valid.

A stride direction of the second read base address may be a width direction of the input feature matrix.

The preset value may be determined according to the width of the filter matrix, the width of the input feature matrix, and the width of the register for caching the input feature values.

Taking the scenario in FIG. 1 as an example, the width of the input feature matrix is 4, and the width of the filter matrix is 2. In a first case, it is assumed that a storage depth of the register (referred to a register G1) for caching the input feature values in the computing units is greater than or equal to the width (4) of the input feature matrix. For example, the register G1 may cache the input feature values x31, x32, x33, and x34 at one time, and it is assumed that storage addresses of x31, x32, x33, and x34 in the register G1 may be Address®, Address1, Address2, and Address3, respectively. Therefore, initial values of both the input feature value read address and the second read base address may be Address0. For example, when the second read base address is the initial value Address® and the count value of the first counter is greater than the width (2) of the filter matrix, the second read base address may be incremented by one stride which is equal to 1, that is, the value of the second read base address is Address 1, and the input feature value read address may be assigned to Address1. In one embodiment, the preset value may be determined according to the width of the filter matrix and the width of the input feature matrix, for example, the preset value is Address 2. In a second case, it is assumed that the storage depth of the register G1 for caching the input feature values in the computing units is less than or equal to the width (4) of the input feature matrix. For example, the register G1 may cache the input feature values x31, x32, and x33 at one time, and it is assumed that the storage addresses of x31, x32, and x33 in the register G1 may be Address®, Address1, and Address2, respectively. Therefore, initial values of both the input feature value read address and the second read base address may be Address0. For example, when the second read base address is the initial value Address® and the count value of the first counter is greater than the width (2) of the filter matrix, the second read base address may be incremented by one stride which is equal to 1, that is, the value of the second read base address is Address1, and the input feature value read address may be assigned to Address1. In one embodiment, the preset value may be not only related to the width of the filter matrix and the width of the input feature matrix, but also related to the storage depth of the register G1. In one embodiment, the preset value may be Address 1.

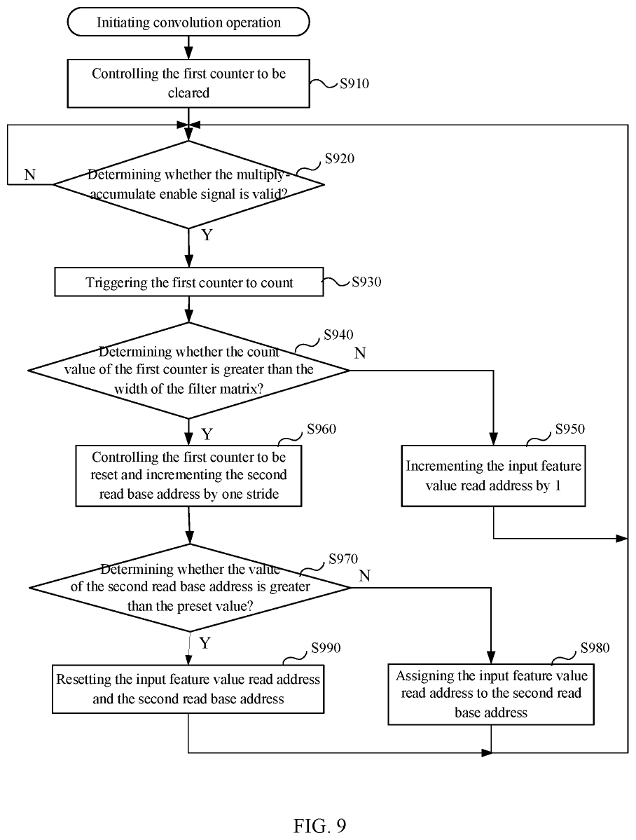

For example, FIG. 9 illustrates another schematic flow chart of a method for generating an input feature value read address according to various disclosed embodiments of the present disclosure. The method may include initiating convolution operations of a hidden layer of the deep convolutional neural network. At S910, the first counter may be controlled to be cleared and the input feature value read address may be cleared. At S920, whether the multiply-accumulate enable signal is valid may be determined; if yes, go to S930 and if no, go back to S920. At S930, the first counter may be triggered to increment 1. At S940, whether the count value of the first counter is greater than the width of the filter matrix may be determined; if no, go to S950, and if yes, go to S960. At S950, the input feature value read address may be incremented by 1; and go back to S920. At S960, the first counter may be controlled to be reset and the second read base address may be incremented by one stride. At S970, whether the value of the second read base address is greater than the preset value may be determined; if no, go to S980, and if yes, go to S990. At S980, the input feature value read address may be assigned to the second read base address; and go back to S920. At S990, the input feature value read address and the second read base address may be reset; and go back to S920.

Scenario 4: the depth of the input feature matrix may be greater than 1, and the number of digits of the input feature values cached in the computing units may be greater than the width of the filter matrix.

The controller 210 may include the first counter, the first processor, the second counter, the second processor, and a third counter. The first counter may be configured to trigger the counting when the multiply-accumulate enable signal is valid and may further be configured to reset the count value when receiving the reset signal transmitted by the first processor. The first processor may be configured to determine whether the count value of the first counter is greater than the width of the filter matrix; if no, the input feature value read address may be incremented by 1; if yes, the reset signal may be transmitted to the first counter, and the triggering count signal may be transmitted to the second counter. The second counter may be configured to trigger the counting when receiving the triggering count signal and may further be configured to reset the count value when receiving the reset signal transmitted by the second processor. The second processor may be configured to determine whether the count value of the second counter is greater than the depth of the filter matrix. If no, after incrementing the first read base address by one stride and assigning the second read base address to the first read base address, the second read base address may be incremented by the number of strides which is equal to the count value of the third counter, the input feature value read address may be assigned to the second read base address by the second processor. If yes, the reset signal may be transmitted to the second counter and the triggering count signal may be transmitted to the third counter; after resetting the first read base address and assigning the second read base address to the first read base address, the second read base address may be incremented by the number of strides which is equal to the count value of the third counter; and whether the value of the second read base address is greater than a preset value may be determined, if no, the input feature value read address may be assigned to the second read base address, and if yes, the input feature value read address, the second read base address and the third counter may be reset. It should be understood that after the input feature value read address is incremented by 1 each time, return to the step of determining whether the multiply-accumulate enable signal is valid.

The preset value may be determined according to the width of the input feature matrix, the width of the filter matrix, and the storage depth of the register for caching the input feature values. The preset value in scenario 4 may have a same meaning as the preset value in scenario 3, where the preset value may be described in detail in scenario 3.

For example, the stride direction of the first read base address may be in the depth direction of the input feature matrix, and the stride direction of the second read base address may be in the width direction of the input feature matrix.

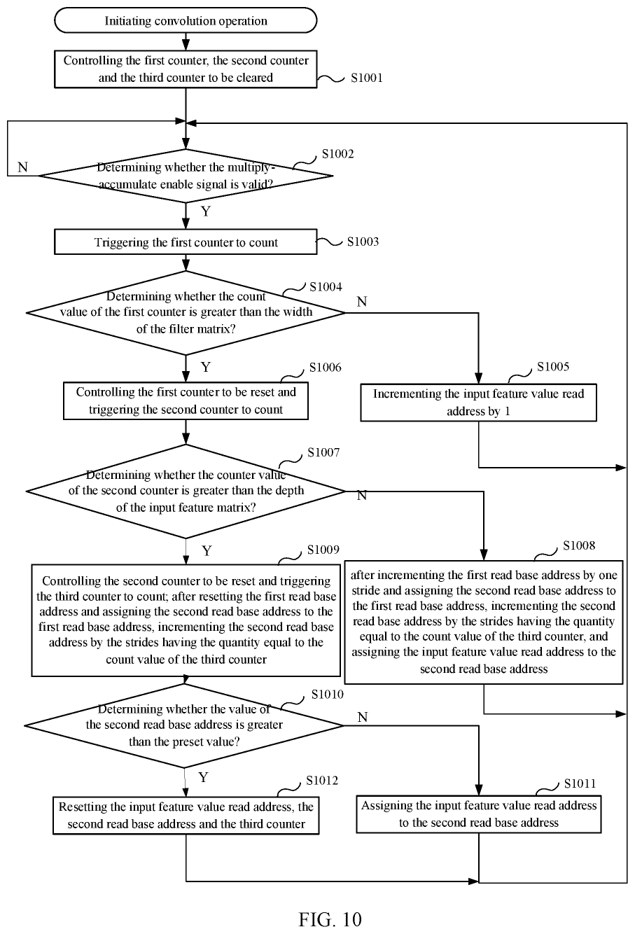

For example, FIG. 10 illustrates another schematic flow chart of a method for generating an input feature value read address according to various disclosed embodiments of the present disclosure. The method may include initiating convolution operations of a hidden layer of the deep convolutional neural network. At S1001, the first counter, the second counter and the third counter may be controlled to be cleared, and the input feature value read address, the first read base address and the second read base address may be reset. At S1002, whether the multiply-accumulate enable signal is valid may be determined; if yes, go to S1003 and if no, go back to S1002. At S1003, the first counter may be triggered to increment 1. At S1004, whether the count value of the first counter is greater than the width of the filter matrix may be determined; if no, go to S1005, and if yes, go to S1006. At S1005, the input feature value read address may be incremented by 1; and go back to S1002. At S1006, the first counter may be controlled to be reset, and the second counter may be triggered to start counting. At S1007, whether the counter value of the second counter is greater than the depth of the input feature matrix may be determined; if no, go to S1008, and if yes, go to S1009. At S1008, after incrementing the first read base address by one stride and assigning the second read base address to the first read base address, the second read base address may be incremented by the number of strides which is equal to the count value of the third counter, and the input feature value read address may be assigned to the second read base address; and go back to S1002. At S1009, the second counter may be controlled to be reset and the third counter may be triggered to start counting; after resetting the first read base address and assigning the second read base address to the first read base address, and the second read base address may be incremented by the number of strides which is equal to the count value of the third counter. At S1010, whether the value of the second read base address is greater than a preset value may be determined, if no, go to S1011, and if yes, go to S1012. At S1011, the input feature value read address may be assigned to the second read base address; and go back to S1002. At S1012, the input feature value read address, the second read base address and the third counter may be reset; and go back to S1002.

Optionally, in some embodiments, the control information may further include the filter weighted value read address. The computing units may perform the multiply-accumulate operations on the filter weighted values and the input feature values according to the control information. For example, the computing units may be configured to obtain target weighted values from the filter weighted values and perform the multiply-accumulate operations on the target weighted values and the input feature values according to the filter weighted value read address.

For example, for different scenarios, the methods for generating the filter weighted value read address by the controller 210 may be different, as the following.

Scenario 5: the depth of the input feature matrix may be equal to 1.

The controller 210 may include a fourth counter and a third processor. The fourth counter may be configured to trigger the counting when the multiply-accumulate enable signal is valid and may further be configured to reset the count value after receiving the reset signal transmitted by the third processor. The third processor may be configured to determine whether the count value of the fourth counter is greater than the width of the filter matrix; if no, the filter weighted value read address may be incremented by 1; and if yes, the reset signal may be transmitted to the fourth counter and the filter weighted value read address may be reset. It should be understood that after the filter weighted value read address is incremented by 1 each time, return to the step of determining whether the multiply-accumulate enable signal is valid.

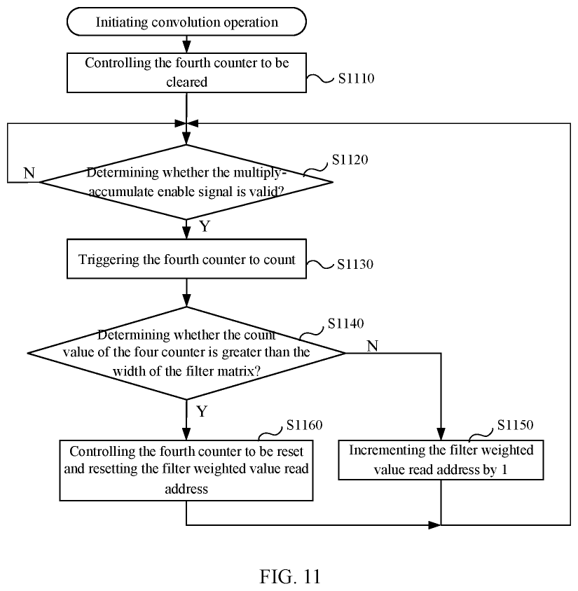

For example, FIG. 11 illustrates a schematic flow chart for generating a filter weighted value read address according to various disclosed embodiments of the present disclosure. The method may include initiating convolution operations of a hidden layer of the deep convolutional neural network. At S1110, the fourth counter may be controlled to be cleared, and the filter weighted value read address may be reset. At S1120, whether the multiply-accumulate enable signal is valid may be determined; if yes, go to S1130 and if no, go back to S1120. At S1130, the fourth counter may be triggered to increment 1. At S1140, whether the count value of the fourth counter is greater than the width of the filter matrix may be determined; if no, go to S1150, and if yes, go to S1160. At S1150, the filter weighted value read address may be incremented by 1; and go back to S1120. At S1160, the fourth counter may be controlled to be reset, and the filter weighted value read address may be reset; and go back to S1120.

Scenario 6: the depth of the input feature matrix may be greater than 1.

The controller 210 may further include the fourth counter, the third processor, a fifth counter and a fourth processor. The fourth counter may be configured to trigger the counting when the multiply-accumulate enable signal is valid and may further be configured to reset the count value when receiving the reset signal transmitted by the third processor. The third processor may be configured to determine whether the count value of the fourth counter is greater than the width of the filter matrix; if no, the filter weighted value read address may be incremented by 1; and if yes, the reset signal may be transmitted to the fourth counter and the triggering count signal may be transmitted to the fifth counter. The fifth counter may be configured to trigger the counting when receiving the triggering count signal and may further be configured to reset the count value when receiving the reset signal transmitted by the fourth processor. The fourth processor may be configured to determine whether the count value of the fifth counter is greater than the depth of the filter matrix; if no, the third read base address may be incremented by one stride and the filter weighted value read address may be assigned to the third read base address; and if yes, the reset signal may be transmitted to the fifth counter and the filter weighted value read address and the third read base address may be reset. It should be understood that after the filter weighted value read address is incremented by 1 each time, return to the step of determining whether the multiply-accumulate enable signal is valid.

For example, the stride direction of the third read base address may be in the depth direction of the filter matrix.

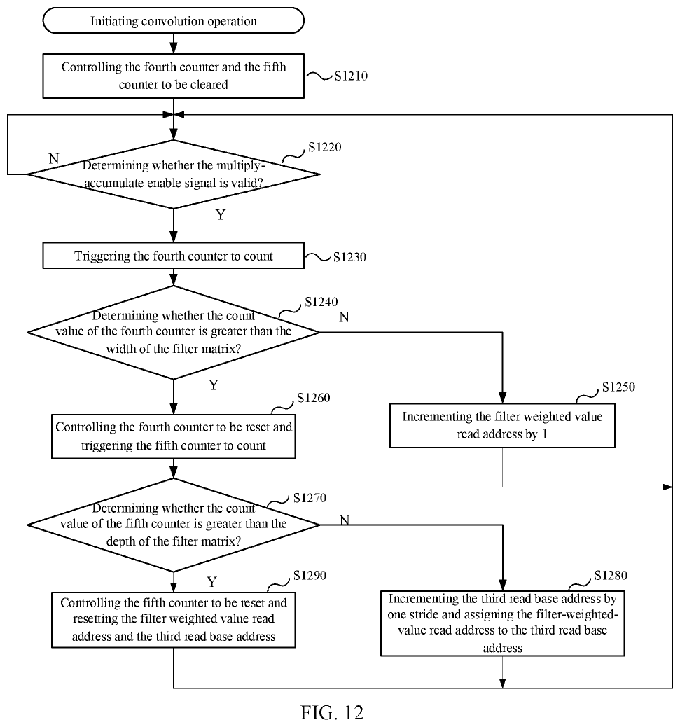

For example, FIG. 12 illustrates another schematic flow chart for generating a filter weighted value read address according to various disclosed embodiments of the present disclosure. The method may include initiating convolution operations of a hidden layer of the deep convolutional neural network. At S1210, the fourth counter and the fifth counter may be controlled to be cleared, and the filter weighted value read address and the third read base address may be reset. At S1220, whether the multiply-accumulate enable signal is valid may be determined; if yes, go to S1230 and if no, go back to S1220. At S1230, the fourth counter may be triggered to increment 1. At S1240, whether the count value of the fourth counter is greater than the width of the filter matrix may be determined; if no, go to S1250, and if yes, go to S1260. At S1250, the filter weighted value read address may be incremented by 1; and go back to S1220. At S1260, the fourth counter may be controlled to be reset, and the fifth counter may be triggered to start counting. At S1270, whether the count value of the fifth counter is greater than the depth of the filter matrix may be determined; if no, go to S1280, and if yes, go to S1290. At S1280, the third read base address may be incremented by one stride and the filter weighted value read address may be assigned to the third read base address. At S1290, the fifth counter may be controlled to be reset, and the filter weighted value read address and the third read base address may also be reset; and go back to S1220.

Optionally, in some above-mentioned embodiments in conjunction with FIGS. 7-10, in the case that the depth of the filter matrix is greater than 1, the controller may further include a sixth counter. The sixth counter may be configured to trigger the counting when receiving the triggering count signal and may further be configured to reset the count value when receiving the reset signal. When the count value of the first counter is determined to be greater than the width of the filter matrix, the first processor may be configured to transmit the reset signal to the first counter and transmit the triggering count signal to the sixth counter. The first processor may further be configured to determine whether the value of the sixth counter is greater than the depth of the filter matrix; if no, the input feature value read address may be assigned to the first read base address; and if yes, the reset signal may be transmitted to the sixth counter and the triggering count signal may be transmitted to the second counter. It should be understood that after the input feature value read address is incremented by 1 each time, return to the step of determining whether the multiply-accumulate enable signal is valid.

The preset value may be determined according to the width of the input feature matrix, the width of the filter matrix and the storage depth of the register for caching the input feature values. The preset value in scenario 4 may have a same meaning as the preset value in scenario 3, where the preset value may be described in detail in scenario 3.

For example, the stride direction of the first read base address may be in the depth direction of the input feature matrix, and the stride direction of the second read base address may be in the width direction of the input feature matrix.

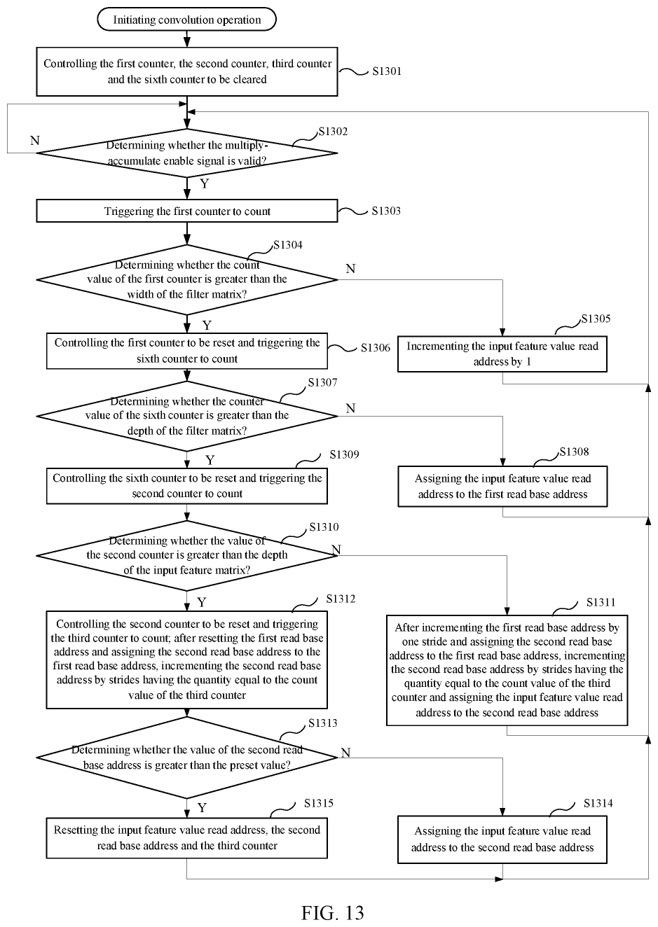

For example, FIG. 13 illustrates another schematic flow chart of a method for generating an input feature value read address according to various disclosed embodiments of the present disclosure. The method may include initiating convolution operations of a hidden layer of the deep convolutional neural network. At S1301, the first counter, the second counter, the third counter and the sixth counter may be controlled to be cleared, and the input feature value read address, the first read base address and the second read base address may be reset. At S1302, whether the multiply-accumulate enable signal is valid may be determined; if yes, go to S1303 and if no, continue back to S1302. At S1303, the first counter may be triggered to increment 1 (i.e., start counting). At S1304, whether the count value of the first counter is greater than the width of the filter matrix may be determined; if no, go to S1305, and if yes, go to S1306. At S1305, the input feature value read address may be incremented by 1; and go back to S1302. At S1306, the first counter may be controlled to be reset, and the sixth counter may be triggered to start counting. At S1307, whether the counter value of the sixth counter is greater than the depth of the filter matrix may be determined; if no, go to S1308, and if yes, go to S1309. At S1308, the input feature value read address may be assigned as the first read base address; and go back to S1302. At S1309, the sixth counter may be controlled to be reset, and the second counter may be triggered to start counting. At S1310, whether the value of the second counter is greater than the depth of the input feature matrix may be determined, if no, go to S1311, and if yes, go to S1312. At S1311, after incrementing the first read base address by one stride and assigning the second read base address to the first read base address, the second read base address may be incremented by the number of strides which is equal to the count value of the third counter, and the input feature value read address may be assigned to the second read base address; and go back to S1302. At S1312, the second counter may be controlled to be reset and the third counter may be triggered to start counting; after resetting the first read base address and assigning the second read base address to the first read base address, the second read base address may be incremented by the number of strides which is equal to the count value of the third counter. At S1313, whether the value of the second read base address is greater than the preset value may be determined; if no, go to S1314 and if yes, go to S1315. At S1314, the input feature value read address may be assigned to the second read base address; and go back to S1302. At S1315, the input feature value read address, the second read base address and the third counter may be reset; and go back to S1302.

Optionally, in some embodiments, when the second processor determines that the count value of the second counter is not greater than the depth of the input feature matrix, the operation “after incrementing the first read base address by one stride and assigning the second read base address to the first read base address, the second read base address may be incremented by the number of strides which is equal to the count value of the third counter, and the input feature value read address may be assigned to the second read base address” may be implemented by the following manner: the second read base address may be incremented by the storage width stride of the register caching the input feature values, and the input feature values may be assigned to the second base read address.

For example, it is assumed that one register stores input feature values shown in Table 1.

TABLE 1

| | | | | |
|---|---|---|---|---|
| 1-11 | 1-12 | 1-13 | 1-14 | 1-15 |
| 2-11 | 2-12 | 2-13 | 2-14 | 2-15 |

In the exemplary Table 1, the storage depth of the register is 2 and the storage width of the register is 5.

As described above, the stride direction of the first read base address may be in the depth direction of the input feature matrix. In other words, one incremented stride of the first read base address may be equivalent to the stride of the storage width of the register for caching the input feature values.

Optionally, in some embodiments, the filter weighted values of the plurality of filter matrices may be cached in the filter register. In such scenario, the controller may include a seventh counter. The seventh counter may be configured to start counting when receiving the triggering count signal and reset the count value when receiving the reset signal.

When the count value of the fifth counter is determined to be greater than the depth of the filter matrix, the fourth processor may be configured to transmit the reset signal to the fifth counter and transmit the triggering count signal to the seventh counter. The fourth processor may further be configured to determine whether the value of the seventh counter is greater than the number of the plurality of filter matrices; if no, the filter weighted value read address may be assigned to the fourth read base address which may be an initial cache address of the filter weighted value in the filter register in a next filter matrix; and if yes, the reset signal may be transmitted to the seventh counter, and the filter weighted value read address, the third read base address and the fourth read base address may be reset. It should be understood that after the input feature value read address is incremented by 1 each time, return to the step of determining whether the multiply-accumulate enable signal is valid.

It should be noted that for each filter matrix in the plurality of filter matrices, the corresponding filter weighted value read address may be generated according to the methods described in the above-mentioned embodiments.

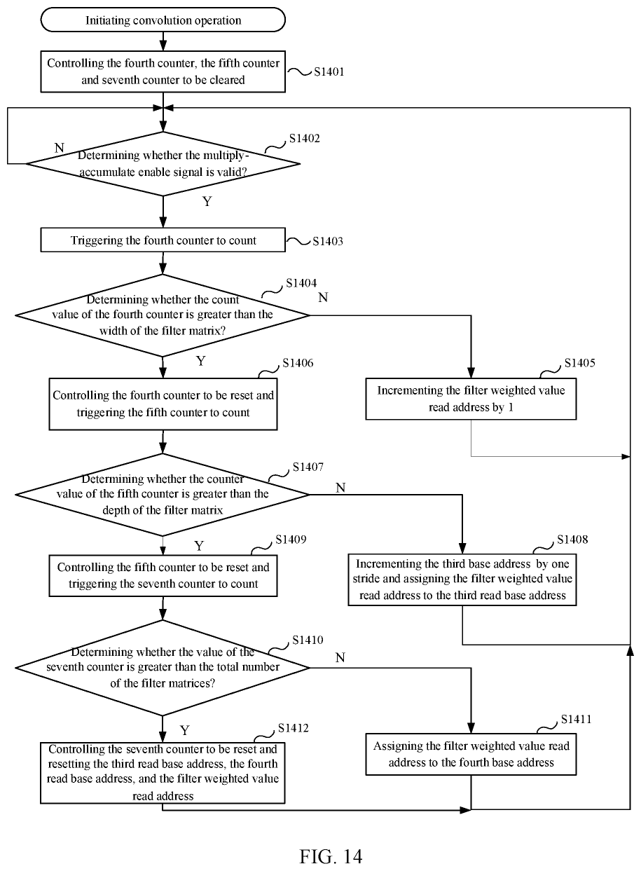

For example, FIG. 14 illustrates another schematic flow chart for generating a filter weighted value read address according to various disclosed embodiments of the present disclosure. The method may include initiating convolution operations of a hidden layer of the deep convolutional neural network. At S1401, the fourth counter, the fifth counter, the seventh counter may be controlled to be cleared, and the filter weighted value read address and the third read base address may be reset. At S1402, whether the multiply-accumulate enable signal is valid may be determined; if yes, go to S1403 and if no, go back to S1402. At S1403, the fourth counter may be triggered to increment 1. At S1404, whether the count value of the fourth counter is greater than the width of the filter matrix may be determined; if no, go to S1405, and if yes, go to S1406. At S1405, the filter weighted value read address may be incremented by 1 and to back to S1402. At S1406, the fourth counter may be controlled to be reset, and the fifth counter may be triggered to start counting. At S1407, whether the counter value of the fifth counter is greater than the depth of the filter matrix may be determined; if no, go to S1408, and if yes, go to S1409. At S1408, the third base address may be incremented by one stride and the filter weighted value read address may be assigned to the third read base address. At S1409, the fifth counter may be reset, and the seventh counter may be triggered to start counting. At S1410, whether the value of the seventh counter is greater than the total number of the filter matrices may be determined; if no, go to S1411, and if yes, go to S1412. At S1411, the filter weighted value read address may be assigned to the fourth base address. The fourth base address may represent an initial cache address of the weighted value of one filter matrix without performing the filter weighted value read address generation in the plurality of filter matrices. At S1412, the seventh counter may be controlled to be reset, and the third read base address, the fourth read base address and the filter weighted value read address may be reset; and go back to S1402.

The arithmetic device provided in one embodiment may perform convolution operations of the plurality of filter matrices in parallel.

It should be noted that the first processor, the second processor, the third processor, and the fourth processor in the above-mentioned embodiments may merely for convenience of description and may not be used to limit the protection scope of the present disclosure. For example, the first processor and the second processor may be two independent processors in the controller; or the first processor and the second processor may be a same processor in the controller.

Optionally, in some above-mentioned embodiments, the input feature values processed by the arithmetic device 200 may be partial or total input feature values in the input feature image.

For example, the input feature values inputted by the network on chip unit to the arithmetic device 200 through XBUS may be partial or total input feature values in the input feature matrix corresponding to an entire input feature image.

In order to better understand the solutions provided by the present disclosure, the arithmetic process of a specific deep convolutional neural network convolutional layer may be described with conjunction with FIG. 14 hereinafter.

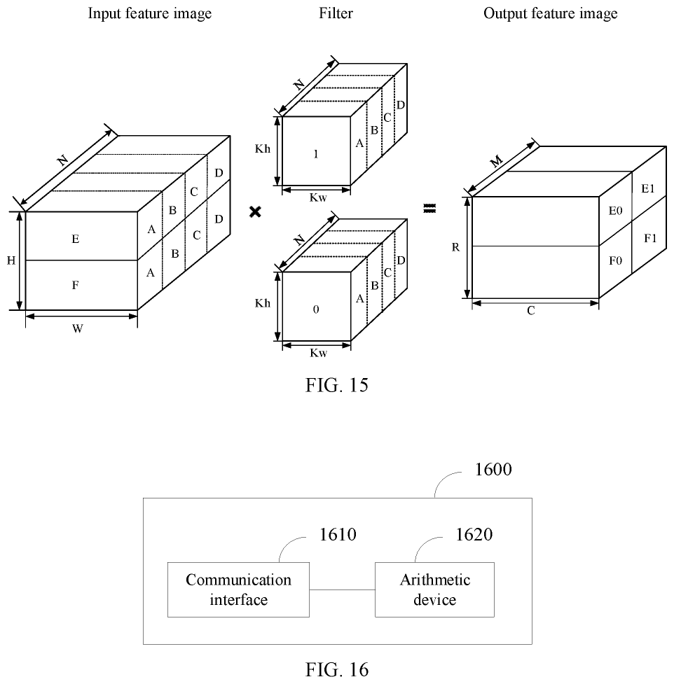

As shown in FIG. 15, the input feature matrix corresponding to the input feature map is N two-dimensional H×W matrices, and the filter is two sets of N two-dimensional Kh×Kw filter matrices. The input feature matrix and two sets of filter matrices may be multiplied to output two two-dimensional output feature R×C matrices.

Before performing the convolution operation by the arithmetic device 200 provided in present disclosure, a slicing operation may be performed first.

The slicing operation may include slicing the input feature matrix into two blocks along a H direction and into four blocks along a N direction by a configuration tool. That is, the input feature matrix is divided into eight blocks, denoted as (E, A), (E, B), (E, C), (E, D), (F, A), (F, B), (F, C) and (F, D).

At the same time, the filter matrix may be divided into four blocks, respectively including A, B, C and D, along the N direction by the configuration tool.

Then, the convolution operation may be performed using the arithmetic device 200 provided by the present disclosure.

First, the block (E, A) of the input feature matrix and blocks A of two sets of filter matrices may be sent into the array of computing units 222 of the arithmetic device, thereby obtaining a first portion summation matrix.

Then, the block (E, B) of the input feature matrix, blocks B of two sets of filter matrices, and the first portion summation matrix may be sent into the array of computing units, thereby obtaining a second portion summation matrix.

Next, the block (E, C) and the block (E, D) of the input feature matrix, blocks C and blocks D of two sets of filter matrices, and the portion summation matrix generated each time may be sent into the array of computing units, thereby obtaining two data blocks E0 and E1 of the output feature matrix.

Similarly, four data blocks (F, A), (F, B), (F, C), and (F, D) of the input feature matrix and four data blocks of A, B, C and D of two sets of filter matrices may be sequentially sent to the computing unit array, thereby generating two data blocks F0 and F1 of the output feature matrix.

As shown in FIG. 16, the embodiments of the present disclosure further provide a chip 1600. The chip 1600 may include a communication interface 1610 and an arithmetic device 1620. The arithmetic device 1620 may correspond to the arithmetic device 200 provided in the above-mentioned embodiments. The communication interface 1610 may be configured to obtain data to be processed by the arithmetic device 1620 and output operation results of the arithmetic device 1620.

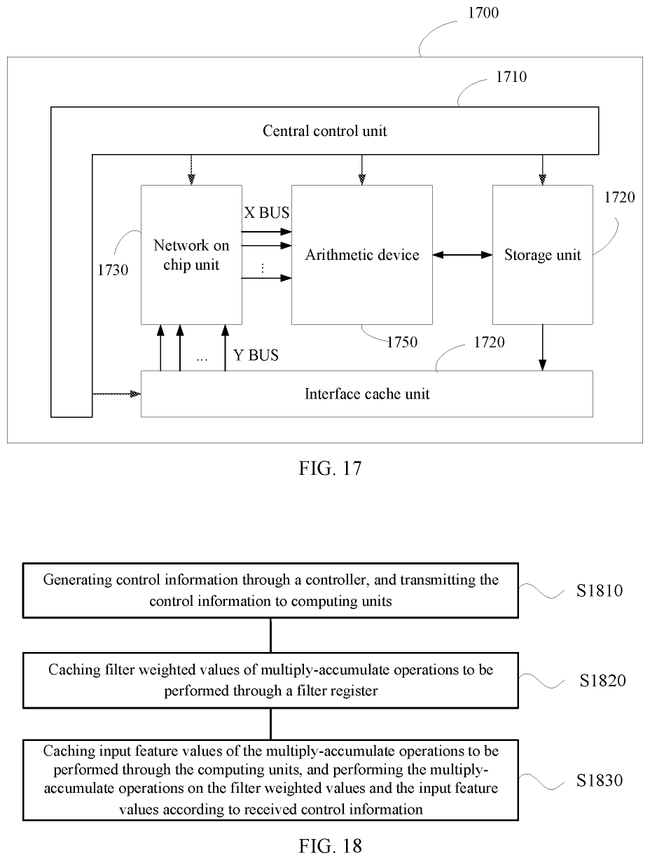

As shown in FIG. 17, the embodiments of the present disclosure further provide a device 1700 for processing the neural network. The device 1700 may include a processor 1710, an interface cache unit 1720, a network on chip unit 1730, a storage unit 1740, and an arithmetic device 1750 which may correspond the arithmetic device 200 provided in the above-mentioned embodiments.

The processor 1710 may be configured to read configuration information of the convolutional neural network and distribute control information corresponding to the configuration information to the interface cache unit 1720, the network on chip unit 1730, the arithmetic device, and the storage unit 1740.

The interface cache unit 1720 may be configured to input feature matrix information and filter weighted value information to the network on chip unit 1730 through a column bus according to the control information of the processor 1710.

The network on chip unit 1730 may be configured to map the input feature matrix information and the filter weighted value information received from the column bus onto XBUS according to the control information of the processor 1710, and is configured to input the input feature matrix information and the filter weighted value information into the arithmetic device through the row bus.

The storage unit 1740 may be configured to receive and cache output results outputted by the arithmetic device. If the output results outputted by the arithmetic device are intermediate results, the storage unit 1740 may further be configured to input the intermediate results into the arithmetic device 1750.

For example, the processor 1710 may be configured to read the configuration information of the deep convolutional neural network and distribute the control information to other modules.

The control information may include at least one of the following: the input feature matrix for each network layer, the output feature matrix, the size of the filter matrix, the address of the above-mentioned data in DRAM, the stride and padding values of the convolution operation, the network layer type, the mapping manner of each network layer in the computing device 1750.

The address information of the above-mentioned data in DRAM may include a destination interface number of the input feature value and a destination interface number of the filter weight.

Optionally, the processor 1710 may further be responsible for receiving information such as startup and resetting transmitted by an upper module (e.g., SOC) and for converting such information to control signals corresponding to other modules, thereby being transmitted to each module. At the same time, the modules may be responsible for reporting status information of each module and interruption signals of errors and processing termination to the upper module.

The interface cache unit 1720 may be configured to read the input feature matrix and the filter weighted values from DRAM and transmit the input feature matrix and the filter weighted values to the network on chip unit 1730 through different YBUSes according to the configuration information.

Optionally, the interface cache unit 1720 may further be responsible for receiving the convolution operation results outputted by the storage unit 1740, and writing data encapsulated with specific formats back into DRAM.

The network on chip unit 1730 may be configured to forward data transmitted on N YBUSes to M XBUSes according to the configuration information. The input feature matrix and the filter weighted values may be transmitted to the arithmetic device 1750 through XBUS.

For example, the information transmitted on each X/Y BUS may include the input feature values, destination interface numbers of the input feature values, valid identifiers of the input feature values, the filter weighted values, destination interface numbers of the filter weighted values, valid identifiers of the filter weighted values, and the like.

The arithmetic device 1750 may be configured to perform the convolution operations on the input feature values and the filter weighted values.

For example, the intermediate results and the final results computed by the arithmetic device 1750 may be transmitted to the storage unit 1740.

The storage unit 1740 may be configured to cache the intermediate results of the arithmetic device 1750 and re-transmit the intermediate results to the arithmetic device 1750 for accumulation according to the control information.

Optionally, the storage unit 1740 may further be responsible for forwarding the final results obtained by the arithmetic device 1750 to the interface cache unit 1720.

It should be understood that, when processing certain layers of the convolutional neural network, the storage unit 1740 may be merely responsible for forwarding the final results of the arithmetic device 1750.

The present disclosure may be applicable to the convolution neural network (CNN), and may also be applicable to other neural network types including a pooling layer.

The device embodiments of the present disclosure are described above, and the method embodiments of the present disclosure are described hereinafter. It should be understood that the description of the method embodiments and the description of the device embodiments may correspond to each other, so details which are not described in detail may refer to the above-mentioned device embodiments, which may not be described for brevity herein.

As shown in FIG. 18, the embodiments of the present disclosure further provide a method for the neural network, and the method may be applied to the arithmetic device described in the above-mentioned device embodiments. The arithmetic device may include a controller and a multiply-accumulate unit group. The multiply-accumulate unit group may include a filter register and the plurality of computing units, and the filter register may be connected to the plurality of computing units. The method may include the following:

S1810, configured to generate control information through the controller and transmit the control information to the computing units;

S1820, configured to cache filter weighted values of the multiply-accumulate operations to be performed through the filter register; and

S1830, configured to cache input feature values of the multiply-accumulate operations to be performed through the computing units and perform the multiply-accumulate operations on the filter weighted values and the input feature values according to received control information.

Optionally, in some embodiments, the control information may include the multiply-accumulate enable signal; and the multiply-accumulate operations may be performed on the filter weighted values and the input feature values according to the control information received by the computing unit, including performing the multiply-accumulate operations on the filter weighted values and the input feature values through the computing units when the multiply-accumulate enable signal is valid.

Optionally, in some embodiments, the control information may further include the input feature value read address; and the multiply-accumulate operations may be performed on the filter weighted values and the input feature values according to the control information received by the computing units, including obtaining target feature values from the input feature values through the computing units according to the input feature value read address and performing the multiply-accumulate operations on the target feature values and the filter weighted values through the computing units.

Optionally, in some embodiments, the control information may further include the filter weighted value read address; and the multiply-accumulate operations may be performed on the filter weighted values and the input feature values according to the control information received by the computing units, including obtaining target weighted values from the filter weighted values through the computing units according to the filter weighted value read address and performing the multiply-accumulate operations on the target weighted values and the input feature values through the computing units.

Optionally, in some embodiments, the controller may include the first counter and the first processor. The first counter may start counting when receiving the triggering count signal and perform resetting when receiving the reset signal. The input feature value read address may be generated through the controller by the following. The first counter may be triggered to count through the first processor when the multiply-accumulate enable signal is valid; whether the count value of the first counter is greater than the width of the filter matrix may be determined by the first processor; and if no, the input feature value read address may be incremented by 1, and if yes, the reset signal may be transmitted to the first counter and the input feature value read address may be reset.

Optionally, in some embodiments, the controller may include the second counter and the second processor. The second counter may start counting when receiving the triggering count signal and perform resetting when receiving the reset signal. The count value of the first counter is determined to be greater than the width of the filter matrix by the first processor, and the method may include the following. The reset signal may be transmitted to the first counter and the triggering count signal may be transmitted to the second counter through the first processor; whether the count value of the second counter is greater than the depth of the filter matrix may be determined by the second processor; and if no, the first read base address may be incremented by one stride and the input feature value read address may be assigned to the first read base address; and if yes, the reset signal may be transmitted to the second counter, and the input feature value read address and the first read base address may be reset.

Optionally, in some embodiments, the controller may further include the sixth counter. The sixth counter may trigger the counting when receiving the triggering count signal and reset the count value when receiving the reset signal.

In the case that the count value of the first counter is determined to be greater than the width of the filter matrix by the first processor, the method may further include the following:

the reset signal may be transmitted to the first counter and the triggering count signal may be transmitted to the sixth counter through the first processor;

whether the count value of the sixth counter is greater than the depth of the filter matrix may be determined by the first processor; and if no, the input feature value read address may be assigned to the first read base address; and if yes, the reset signal may be transmitted to the sixth counter, and the triggering count signal may be transmitted to the second counter.

Optionally, in some embodiments, in the case that the count value of the first counter is determined to be greater than the width of the filter matrix by the first processor, the method may further include the following: the reset signal may be transmitted to the first counter through the first processor and the second read base address may be incremented by one stride; whether the value of the second read base address is greater than a preset value may be determined; if no, the input feature value read address may be assigned to the second read base address, and if yes, input feature value read address and the second read base address may be reset. The preset value may be determined according to the width of the filter matrix, the width of the input feature matrix, and the width of the register for caching the input feature values.

Optionally, in some embodiments, the controller may further include the third processor. The third counter may trigger the counting when receiving the triggering count signal and reset the count value when receiving the reset signal.

In the case that the count value of the second counter is determined to be greater than the depth of the filter matrix by the second processor, the method may further include the following: the reset signal may be transmitted to the second counter and the triggering count signal may be transmitted to the third counter through the second processor; and after resetting the first read base address and assigning the second read base address to the first read base address, the second read base address may be incremented by the number of strides which is equal to the count value of the third counter; whether the value of the second read base address is greater than the preset value may be determined, if no, the input feature value read address may be assigned to the second read base address, and if yes, the input feature value read address, the second read base address and the third counter may be reset.

In the case that the count value of the second counter is determined to be not greater than the depth of the filter matrix by the second processor, and the method may further include the following: after incrementing the first read base address by one stride and assigning the second read base address to the first read base address by the second processor, the second read base address may be incremented by the number of strides which is equal to the count value of the third counter and the input feature value read address may be assigned to the second read base address by the second processor.

The preset value may be determined according to the width of the filter matrix, the width of the input feature matrix, and the storage depth of the register for caching the input feature values.

Optionally, in some embodiments, the controller may include the fourth counter and the third processor. The fourth counter may start counting when receiving the triggering count signal and reset the count value when receiving the reset signal. Generating the filter weighted value read address through the controller may include the following: when the multiply-accumulate enable signal is valid, the triggering count signal may be transmitted to the fourth counter through the third processor; the third processor may be configured to determine whether the count value of the fourth counter is greater than the width of the filter matrix; if no, the filter weighted value read address may be incremented by 1; and if yes, the reset signal may be transmitted to the fourth counter and the filter weighted value read address may be reset.

Optionally, in some embodiments, the controller may include the fifth counter and the fourth processor. The fifth counter may start counting when receiving the triggering count signal and reset the count value when receiving the reset signal. In the case that the count value of the fourth counter is determined to be greater than the width of the filter matrix by the third processor, and the method may include the following: the reset signal may be transmitted to the fourth counter and the triggering count signal may be transmitted to the fifth counter through the third processor; whether the count value of the fifth counter is greater than the depth of the filter matrix may be determined by the fourth processor; if no, the first read base address may be incremented by one stride and the filter weighted value read address may be assigned to the first read base address; and if yes, the reset signal may be transmitted to the fifth counter, and the filter weighted value read address and the first read base address may be reset.

Optionally, in some embodiments, the filter weighted values of the plurality of filter matrices may be cached in the filter register. In such scenario, the controller may include the seventh counter. The seventh counter may be configured to start counting when receiving the triggering count signal and reset the count value when receiving the reset signal.

When the count value of the fifth counter is determined to be greater than the depth of the filter matrix through the fourth processor, and the method may include the following: the reset signal may be transmitted to the fifth counter and the triggering count signal may be transmitted to the seventh counter by the fourth processor; whether the value of the seventh counter is greater than the number of the plurality of filter matrices may be determined; if no, the filter weighted value read address may be assigned to the fourth read base address which may be the initial cache address of the filter weighted value in the filter register in a next filter matrix of the plurality of filter matrices; and if yes, the reset signal may be transmitted to the seventh counter, and the filter weighted value read address, the third read base address and the fourth read base address may be reset. It should be understood that after the input feature value read address is incremented by 1 each time, return to the step of determining whether the multiply-accumulate enable signal is valid.

It should be understood that, for each filter matrix in the plurality of filter matrices, the corresponding filter weighted value read address may be generated according to the methods described in above-mentioned embodiments, and details may refer to the above-mentioned embodiments, which may not be described for brevity herein.

Optionally, in some embodiments, at least two of the plurality of computing units may be connected the same row bus. The input feature values of the multiply-accumulate operations to be performed may be cached through the computing units, including receiving and caching the input feature values from the row bus through the computing units connected the same row bus where the destination interface addresses match the interface addresses of the computing units.

Optionally, in some embodiments, the interface addresses of the computing units connected to a same filter register may be different.

Optionally, in some embodiments, the interface addresses of the computing units connected to a same row bus may be different.

Optionally, in some embodiments, the filter register may be connected to the row bus. The filter weighted values of the multiply-accumulate operations to be performed may be cached through the filter register, including caching the filter weighted values from the row bus through the filter register where the destination interface addresses match the interface address of the filter register.

Optionally, in some embodiments, the arithmetic device may include the plurality of multiply-accumulate unit groups, and the computing units and the filter register in the plurality of multiply-accumulate unit groups may be connected to the same row bus.

Optionally, in some embodiments, the interface addresses of the computing units between different multiply-accumulate unit groups in the plurality of multiply-accumulate unit groups may be same; or the interface addresses of the computing units between different multiply-accumulate unit groups in the plurality of multiply-accumulate unit groups may be different.

Optionally, in some embodiments, the interface addresses of the filter registers between different multiply-accumulate unit groups in the plurality of multiply-accumulate unit groups may be same; or the interface addresses of the filter registers between different multiply-accumulate unit groups in the plurality of multiply-accumulate unit groups may be different.

Optionally, in some embodiments, the arithmetic device may include the plurality of multiply-accumulate unit groups. The computing units of the first multiply-accumulate unit group and the computing units of another multiply-accumulate unit group may be connected in the preset order. Or the computing units of the first multiply-accumulate unit group and the computing units of another two multiply-accumulate unit groups may be connected in the preset order, and the order connection may be configured to accumulate the multiply-accumulate results of the computing units connected in the preset order.

Optionally, in some embodiments, the method may further include transmitting the multiply-accumulate operation result of the first computing unit to a computing unit connected to the first computing unit through the first computing unit in the plurality of multiply-accumulate unit groups.

Optionally, in some embodiments, the method may further include, through the second computing unit in the plurality of multiply-accumulate unit groups, receiving the multiply-accumulate operation result of one computing unit connected to the second computing unit and also accumulating the initial multiply-accumulate operation result of the second computing unit with the received multiply-accumulate operation result, thereby obtaining the final multiply-accumulate operation result of the second computing unit.

Optionally, in some embodiments, the computing units in at least one multiply-accumulate unit group of the plurality of multiply-accumulate unit groups may be connected to the storage unit. The method may further include transmitting the multiply-accumulate operation result to the storage unit through the computing unit connected to the storage unit.

Optionally, in some embodiments, the computing units in at least one multiply-accumulate unit group of the plurality of multiply-accumulate unit groups may be connected to the storage unit. The method may further include receiving the data transmitted by the storage unit through the computing unit connected to the storage unit and accumulating the initial local multiply-accumulate operation result with the received data, thereby obtaining the final local multiply-accumulate operation result.

Optionally, in some embodiments, different multiply-accumulate unit groups may be connected to different row buses.

Optionally, in some embodiments, the interface addresses of partial computing units in different multiply-accumulate unit groups may be same.

Optionally, in some embodiments, the computing units in the plurality of multiply-accumulate unit groups may form the computing unit array. The same row in the computing unit array may correspond to at least two multiply-accumulate unit groups.

Optionally, in some embodiments, the input feature values processed by the arithmetic device may be partial or total input feature values in the input feature image.

Optionally, in some embodiments, the input feature values processed by the arithmetic device may include partial of total input feature values in each input feature image of multiple input feature images.

The embodiments of the present disclosure further provide a method for the neural network. The method may be applied to an arithmetic device. The arithmetic device may include a controller and a plurality of multiply-accumulate unit groups, and each multiply-accumulate unit group may include computing units and a filter register connecting to the computing units. The method may include generating control information through the controller and transmitting the control information to the computing units; caching filter weighted values of the multiply-accumulate operations to be performed through each filter register; caching the input feature values of the multiply-accumulate operations to be performed through each computing unit, and performing the multiply-accumulate operations on the input feature values and the filter weighted values cached in the filter register connected to the computing unit according to the control information transmitted by the controller; where the computing units of the first multiply-accumulate unit group and the computing units of another multiply-accumulate unit group may be connected in a preset order. Or the computing units of the first multiply-accumulate unit group and the computing units of another two multiply-accumulate unit groups may be connected in a preset order, and the order connection may be configured to accumulate the multiply-accumulate results of the computing units connected in the preset order.

The embodiment of the present disclosure further provides a computer readable storage medium with stored computer programs. The computer programs may be executed by the computer to implement the method provided by the above-mentioned method embodiments. The computer herein may be an arithmetic device provided by the above-mentioned device embodiments.

The embodiment of the present disclosure further provides a computer program product including instructions, which may be executed by a computer to implement the method provided by the above-mentioned method embodiments.

It is also to be understood that the references to the first, the second, the third, the fourth and various numerical numbers in the above-mentioned description may be merely for convenience of description and are not intended to limit the scope of the disclosure.

In the above-mentioned embodiments, it may be implemented in whole or in part by software, hardware, firmware or any other combinations. In software is used for implementation, it may be implemented in whole or in part in the form of computer program products. The computer program products may include one or more computer instructions. When the computer program instructions are loaded and executed on a computer, the processes or functions described in the embodiments of the present disclosure are generated in whole or in part. The computer may be a general-purpose computer, a special purpose computer, a computer network, or other programmable devices. The computer instructions may be stored in a computer readable storage medium or may be transferred from one computer readable storage medium to another computer readable storage medium. For example, the computer instructions may be transmitted from a website site, a computer, a server or a data center to another website site, another computer, another server or another data center through wired (e.g., coaxial cable, fiber optic, digital subscriber line (DSL)) or wireless (e.g., infrared, wireless, microwave, and the like). The computer readable storage medium may be any available media that may be accessed by a computer or a data storage device such as a server, a data center, or the like that may integrate one or more available media. The usable medium may be a magnetic medium (e.g., a floppy disk, a hard disk, a magnetic tape), an optical medium (e.g., a digital video disc (DVD)), or a semiconductor medium (e.g., a solid-state disk (SSD)).

Those skilled in the art should understand that the elements and algorithm steps of the various above-mentioned embodiments described in the present disclosure may be implemented by electronic hardware or a combination of computer software and electronic hardware. Whether these functions are performed in hardware or software depends on the specific disclosure and design constraints of the technical solutions. Those skilled in the art may use different methods to implement the described functions for each particular disclosure, but such implementation should not be considered to be beyond the scope of the present disclosure.

In some embodiments provided by the present disclosure, it should be understood that the disclosed systems, devices, and methods may be implemented in other manners. For example, the device embodiments described above are merely illustrative. For example, the division of the unit is only a logical function division. In actual implementations, there may be other division manners. For example, multiple units or components may be combined or may be integrated into another system, or some features may be ignored or not executed. In addition, the mutual coupling, direct coupling or communication connection shown or discussed in the above-mentioned embodiments may be the indirect coupling or communication connection through certain interfaces, devices or units, and may be in electrical, mechanical or other forms.

The units described as separate components may or may not be physically separated, and the components displayed as units may or may not be physical units, that is, may be located in one location, or may be distributed to multiple network units. Some or all of the units may be selected according to actual needs to achieve the purpose of the solution of the embodiments.

In addition, each functional unit in each embodiment of the present disclosure may be integrated into one processor, or each unit may be physically separated, or two or more units may be integrated into one unit.

The above-mentioned embodiments are merely specific implementations of the present disclosure. However, the present disclosure is not limited by the above-mentioned embodiments. It is apparent to those skilled in the art that various modifications and variations may be made in the disclosure without departing from the spirit and scope of the disclosure. Thus, if such modifications and variations of the present disclosure fall within the scope of the appended claims, the disclosure is also intended to cover such modifications and variations. The protection scope of this disclosure shall be subject to the protection scope of the claims.

What is claimed is:

1. An arithmetic device for a neural network, comprising:
a controller and multiply-accumulate unit groups, wherein:
a multiply-accumulate unit group includes a filter register and a plurality of computing units, and the filter register is connected to the plurality of computing units;
the controller is configured to generate control information and transmit the control information to the plurality of computing units;
the filter register is configured to cache filter weighted values of multiply-accumulate operations to be performed; and
the plurality of computing units is configured to cache input feature values of the multiply-accumulate operations to be performed and perform the multiply-accumulate operations on the filter weighted values and the input feature values according to received control information.

2. The device according to claim 1, wherein:
the control information includes a multiply-accumulate enable signal; and
the plurality of computing units performs the multiply-accumulate operations on the filter weighted values and the input feature values according to the received control information, wherein the plurality of computing units performing the multiply-accumulate operations includes:
performing the multiply-accumulate operations, by the plurality of computing units, on the filter weighted values and the input feature values when the multiply-accumulate enable signal is valid.

3. The device according to claim 1, wherein:
the control information further includes an input feature value read address; and
the plurality of computing units performs the multiply-accumulate operations on the filter weighted values and the input feature values according to the received control information, wherein the plurality of computing units performing the multiply-accumulate operations includes:
according to the input feature value read address, obtaining target feature values from the input feature values and performing the multiply-accumulate operations on the target feature values and the filter weighted values by the plurality of computing units.

4. The device according to claim 1, wherein:
the control information further includes a filter weighted value read address; and
the plurality of computing units performs the multiply-accumulate operations on the filter weighted values and the input feature values according to the received control information, wherein the plurality of computing units performing the multiply-accumulate operations includes:
according to the filter weighted value read address, obtaining target weighted values from the filter weighted values and performing the multiply-accumulate operations on the target weighted values and the input feature values by the plurality of computing units.

5. The device according to claim 3, wherein:
the controller includes a first counter and a first processor;
the first counter is configured to trigger a counting when the multiply-accumulate enable signal is valid, and is further configured to reset a count value when receiving a reset signal transmitted by the first processor; and
the first processor is configured to determine whether a count value of the first counter is greater than a width of a filter matrix; if the count value of the first counter is not greater than the width of the filter matrix, the first processor is configured to increment the input feature value read address by 1; and if the count value of the first counter is greater than the width of the filter matrix, the first processor is configured to transmit the reset signal to the first counter and reset the input feature value read address.

6. The device according to claim 5, wherein:
the controller further includes a second counter and a second processor;
when the count value of the first counter is determined to be greater than the width of the filter matrix, the first processor is configured to transmit the reset signal to the first counter and transmit a triggering count signal to the second counter;
the second counter is configured to trigger the counting when receiving the triggering count signal and is further configured to reset the count value when receiving a reset signal transmitted by the second processor; and
the second processor is configured to determine whether a count value of the second counter is greater than a depth of the filter matrix; if the count value of the second counter is not greater than the depth of the filter matrix, the second processor is configured to increment a first read base address by one stride, and assign the input feature value read address to the first read base address; and if the count value of the second counter is greater than the depth of the filter matrix, the second processor is configured to transmit the reset signal to the second counter, and reset the input feature value read address and the first read base address.

7. The device according to claim 5, wherein:
when the count value of the first counter is determined to be greater than the width of the filter matrix, the first processor is configured to transmit the reset signal to the first counter and increment a second read base address by one stride, and is configured to determine whether a value of the second read base address is greater than a preset value; if the value of the second read base address is not greater than the preset value, the first processor is configured to assign the input feature value read address to the second read base address; and if the value of the second read base address is greater than the preset value, the first processor is configured to reset the input feature value read address and the second read base address, wherein:
the preset value is determined according to the width of the filter matrix, a width of the input feature matrix, and a width of the register for caching the input feature values.

8. The device according to claim 6, wherein:
the controller further includes a third processor; and a third counter is configured to trigger the counting when receiving the triggering count signal and is further configured to reset the count value when receiving the reset signal;
when the count value of the second counter is determined to be greater than a depth of the input feature matrix, the second processor is configured to transmit the reset signal to the second counter and transmit the triggering count signal to the third counter; and after resetting the first read base address and assigning the second read base address to the first read base address, the second processor is configured to increment the second read base address by strides having a quantity equal to a count value of the third counter, and is further configured to determine whether a value of the second read base address is greater than a preset value, if the value of the second read base address is not greater than the preset value, the second processor is configured to assign the input feature value read address to the second read base address, and if the value of the second read base address is greater than the preset value, the second processor is configure to reset the input feature value read address, the second read base address and the third counter; and
when the count value of the second counter is determined to be not greater than the depth of the input feature matrix, the second processor is configured to increment the first read base address by one stride, and after assigning the second read base address to the first read base address, the second processor is configured to increment the second read base address by the strides having the quantity equal to the count value of the third counter and is configured to assign the input feature value read address to the second read base address, wherein:
the preset value is determined according to the width of the filter matrix, a width of the input feature matrix, and a storage depth of the register for caching the input feature values.

9. The device according to claim 6, wherein:
the controller further includes a sixth counter;
when the count value of the first counter is determined to be greater than the width of the filter matrix, the first processor is configured to transmit the reset signal to the first counter and transmit the triggering count signal to the sixth counter;
the sixth counter is configured to trigger the counting when receiving the triggering count signal and is further configured to reset the count value when receiving the reset signal; and
the first processor is further configured to determine whether a value of the sixth counter is greater than the depth of the filter matrix; if the value of the sixth counter is not greater than the depth of the filter matrix, the first processor is configured to assign the input feature value read address to the first read base address; and if the value of the sixth counter is greater than the depth of the filter matrix, the first processor is configured to transmit the reset signal to the sixth counter and is further configured to transmit the triggering count signal to the second counter.

10. The device according to claim 4, wherein:
the controller includes a fourth counter and a third processor;
the fourth counter is configured to trigger the counting when the multiply-accumulate enable signal is valid and is further configured to reset the count value after receiving a reset signal transmitted by the third processor; and
the third processor is configured to determine whether a count value of the fourth counter is greater than the width of the filter matrix; if the count value of the fourth counter is not greater than the width of the filter matrix, the third processor is configured to increment the filter weighted value read address by 1; and if the count value of the fourth counter is greater than the width of the filter matrix, the third processor is configured to transmit a reset signal to the fourth counter and is further configured to reset the filter weighted value read address.

11. The device according to claim 10, wherein:
the controller further includes a fifth counter and a fourth processor;
when the count value of the fourth counter is determined to be greater than the width of the filter matrix, the third processor is configured to transmit the reset signal to the fourth counter and is further configured to transmit the triggering count signal to the fifth counter;
the fifth counter is configured to trigger the counting when receiving the triggering count signal and is further configured to reset the count value when receiving a reset signal transmitted by the fourth processor; and
the fourth processor is configured to determine whether a count value of the fifth counter is greater than the depth of the filter matrix; if the count value of the fifth counter is not greater than the depth of the filter matrix, the fourth processor is configured to increment the third read base address by one stride and is further configured to assign the filter weighted value read address to the third read base address; and if the count value of the fifth counter is greater than the depth of the filter matrix, the fourth processor is configured to transmit the reset signal to the fifth counter and is further configured to reset the filter weighted value read address and the third read base address.

12. The device according to claim 11, wherein:
the filter register caches filter weighted values of a plurality of filter matrices;
the controller further includes a seventh counter, and the seventh counter is configured to trigger the counting when receiving the triggering count signal and reset the count value when receiving the reset signal; and
when the count value of the fifth counter is determined to be greater than the depth of the filter matrix, the fourth processor is configured to transmit the reset signal to the fifth counter and transmit the triggering count signal to the seventh counter; the fourth processor is further configured to determine whether a value of the seventh counter is greater than a total number of the plurality of filter matrices; if the value of the seventh counter is not greater than the total number of the plurality of filter matrices, the fourth processor is configured to assign the filter weighted value read address to a fourth read base address, where the fourth read base address is an initial cache address of the filter weighted values in the filter register in a next filter matrix of the plurality of filter matrices; and if the value of the seventh counter is greater than the total number of the plurality of filter matrices, the fourth processor is configured to transmit the reset signal to the seventh counter and is further configured to reset the filter weighted value read address, the third read base address and the fourth read base address.

13. The device according to claim 1, wherein:
at least two computing units of the plurality of computing units are connected a same row bus, and the computing units connected to the same row bus are configured to receive and cache input feature values from the row bus wherein destination interface addresses match interface addresses of the computing units.

14. The device according to claim 13, wherein:
the interface addresses of the computing units connected to a same filter register are different.

15. The device according to claim 13, wherein:
the interface addresses of the computing units connected to the same row bus are different.

16. The device according to claim 1, wherein:
the filter register is connected to a row bus and configured to cache filter weighted values from the row bus wherein destination interface addresses match interface addresses of the filter register.

17. The device according to claim 1, wherein:
the arithmetic device includes a plurality of multiply-accumulate unit groups, and the plurality of computing units and the filter registers in the plurality of multiply-accumulate unit groups are connected to a same row bus.

18. The device according to claim 17, wherein:
interface addresses of the plurality of computing units between different multiply-accumulate unit groups in the plurality of multiply-accumulate unit groups are same; or interface addresses of the plurality of computing units between different multiply-accumulate unit groups in the plurality of multiply-accumulate unit groups are different.

19. An arithmetic device for a neural network, comprising:
a controller and a plurality of multiply-accumulate unit groups, wherein:
each multiply-accumulate unit group includes computing units and a filter register connected to the computing units;
the controller is configured to generate control information and transmit the control information to the computing units;
each filter register is configured to cache filter weighted values of multiply-accumulate operations to be performed; and
each computing unit is configured to cache input feature values of the multiply-accumulate operations to be performed and perform the multiply-accumulate operations on the filter weighted values and the input feature values according to control information transmitted by the controller, wherein:
in the plurality of multiply-accumulate unit groups, computing units of a first multiply-accumulate unit group and computing units of another multiply-accumulate unit group are connected in a preset order; or computing units of a first multiply-accumulate unit group and computing units of two other multiply-accumulate unit groups are connected in a preset order; and the order connection is configured to accumulate multiply-accumulate results of the computing units connected in the preset order.

20. A chip for a neural network, comprising:
an arithmetic device, and
a communication interface, configured to obtain data to be processed by the arithmetic device and output arithmetic results of the arithmetic device, wherein the arithmetic device includes:
a controller and multiply-accumulate unit groups, wherein:
a multiply-accumulate unit group includes a filter register and a plurality of computing units, and the filter register is connected to the plurality of computing units;
the controller is configured to generate control information and transmit the control information to the plurality of computing units;
the filter register is configured to cache filter weighted values of multiply-accumulate operations to be performed; and
the plurality of computing units is configured to cache input feature values of the multiply-accumulate operations to be performed and perform the multiply-accumulate operations on the filter weighted values and the input feature values according to received control information.
